(19) United States
(12) Patent Application Publication
(10) Pub. No.: US 2022/0080962 A1
(43) Pub. Date: Mar. 17, 2022

(54) VEHICLE OPERATION USING A BEHAVIORAL RULE MODEL

(71) Applicant: Motional AD LLC, Boston, MA (US)

(72) Inventors: Amitai Bin-Nun, Silver Spring, MD (US); Radboud Duintjer Tebbens, Winchester, MA (US); Hsun-Hsien Chang, Brookline, MA (US); Anne Collin, Cambridge, MA (US)

(21) Appl. No.: 17/471,586

(22) Filed: Sep. 10, 2021

Related U.S. Application Data
(60) Provisional application No. 63/078,062, filed on Sep. 14, 2020.

(51) Int. Cl. B60W 30/095; B60W 60/00

(52) U.S. Cl. CPC B60W 30/0956; B60W 30/0953; B60W 2554/4046; B60W 2420/52; B60W 2554/4049; B60W 60/0015

(57) ABSTRACT

Methods for vehicle operation using a behavioral rule model include receiving sensor data from a first set of sensors and a second set of sensors. The sensor data represents operation of the vehicle with respect to one or more objects. Violations of a behavioral model of the operation of the vehicle are determined based on the sensor data. A first risk level of the one or more violations is determined based on a distribution of events of the operation of the vehicle with respect to the one or more objects. Responsive to the first risk level being greater than a threshold risk level, a trajectory is generated. The trajectory has a second risk level lower than the threshold risk level. The vehicle is operated based on the trajectory to avoid a collision of the vehicle and the one or more objects.

### CROSS-REFERENCE TO RELATED APPLICATIONS

This application is a conversion of U.S. Provisional Application No. 63/078,062, filed on Sep. 14, 2020, and is hereby incorporated by reference in its entirety.

### FIELD OF THE INVENTION

This description relates generally to operation of vehicles and specifically to vehicle operation using a behavioral rule model.

### BACKGROUND

Operation of a vehicle from an initial location to a final destination often requires a user or a vehicle's decision-making system to select a route through a road network from the initial location to a final destination. The route may involve meeting objectives, such as not exceeding a maximum driving time. A complex route can require many decisions, making traditional algorithms for autonomous driving impractical.

### SUMMARY

Methods, systems, and apparatus for vehicle operation using a behavioral rule model are disclosed. In an embodiment, one or more processors of a vehicle operating in an environment receive first sensor data from a first set of sensors of the vehicle and second sensor data from a second set of sensors of the vehicle. The first sensor data represents operation of the vehicle and the second sensor data represents one or more objects located in the environment. The one or more processors determine one or more violations of a stored behavioral model of the operation of the vehicle based on the first sensor data and the second sensor data. The one or more violations are determined with respect to the one or more objects located in the environment. The one or more processors determine a first risk level of the one or more violations based on a stored distribution of events of the operation of the vehicle with respect to the one or more objects. Responsive to the first risk level being greater than a threshold risk level, the one or more processors generate a trajectory for the vehicle. The trajectory has a second risk level lower than the threshold risk level. The second risk level is determined with respect to the one or more objects. The one or more processors operate the vehicle based on the trajectory to avoid a collision of the vehicle and the one or more objects.

In an embodiment, the first set of sensors include at least one of an accelerometer, a steering wheel angle sensor, a wheel sensor, or a brake sensor.

In an embodiment, the first sensor data includes at least one of a speed of the vehicle, an acceleration of the vehicle, a heading of the vehicle, an angular velocity of the vehicle, or a torque of the vehicle.

In an embodiment, the second set of sensors include at least one of a LiDAR, a RADAR, a camera, and a microphone.

In an embodiment, the second sensor data includes at least one of an image of the one or more objects, a speed of the one or more objects, an acceleration of the one or more objects, or a lateral distance between the one or more objects and the vehicle.

In an embodiment, the one or more processors determine the second risk level based on the trajectory and the stored distribution of events of the operation of the vehicle with respect to the one or more objects.

In an embodiment, the stored distribution of events includes a log-normal probability distribution of independent random variables. Each random variable represents a risk level of a hazard of the operation of the vehicle.

In an embodiment, the stored behavioral model of the operation of the vehicle includes multiple rules of operation. Each rule of operation has a priority with respect to each other rule of operation. The priority represents a risk level of the one or more violations of the stored behavioral model.

In an embodiment, a violation of the one or more violations of the stored behavioral model of the operation of the vehicle includes a lateral distance between the vehicle and the one or more objects falling below a threshold lateral distance.

In an embodiment, the priority of the rule of operation is adjusted based on a frequency of the violation.

In an embodiment, a motion planning process of the vehicle is adjusted based on a frequency of the one or more violations of the stored behavioral model to decrease the second risk level.

In an embodiment, a risk level of the motion planning process of the vehicle is determined based on the frequency of the one or more violations of the stored behavioral model.

In an embodiment, one or more processors of a vehicle operating in an environment generate a trajectory based on first sensor data from a first set of sensors of the vehicle and second sensor data from a second set of sensors of the vehicle. The first sensor data represents operation of the vehicle and the second sensor data represents one or more objects located in the environment. The one or more processors determine whether the trajectory causes one or more violations of a stored behavioral model of the operation of the vehicle. The one or more violations are determined with respect to the one or more objects located in the environment. Responsive to determining that the trajectory causes the one or more violations of the stored behavioral model, the one or more processors determine a first risk level of the one or more violations based on a stored distribution of events of the operation of the vehicle with respect to the one or more objects. The one or more processors generate an alternative trajectory for the vehicle. The one or more processors determine that the alternative trajectory has a second risk level higher than the first risk level. The second risk level is determined with respect to the one or more objects. The one or more processors operate the vehicle based on the trajectory to avoid a collision of the vehicle and the one or more objects.

In an embodiment, the stored behavioral model of the operation of the vehicle includes multiple layers. Each layer has a respective position corresponding to a violation of the one or more violations.

In an embodiment, a collision of the vehicle with the one or more objects occurs when the respective position of each layer of the multiple layers aligns.

In an embodiment, a motion planning process of the vehicle is designed, such that a probability of the respective position of each layer of the multiple layers aligning is less than a threshold probability.

In an embodiment, a violation of the one or more violations represents a deceleration of the vehicle exceeding a threshold deceleration.

In an embodiment, a violation of the one or more violations represents a lateral distance from the vehicle to the one or more objects falling below a threshold lateral distance.

In an embodiment, the first set of sensors includes at least one of an accelerometer, a steering wheel angle sensor, a wheel sensor, or a brake sensor.

In an embodiment, the first sensor data includes at least one of a speed of the vehicle, an acceleration of the vehicle, a heading of the vehicle, an angular velocity of the vehicle, or a torque of the vehicle.

In an embodiment, the second set of sensors include at least one of a LiDAR, a RADAR, a camera, and a microphone.

In an embodiment, the second sensor data includes at least one of an image of the one or more objects, a speed of the one or more objects, an acceleration of the one or more objects, or a lateral distance between the one or more objects and the vehicle.

In an embodiment, the one or more processors determine the second risk level based on the alternative trajectory and the stored distribution of events of the operation of the vehicle with respect to the one or more objects.

In an embodiment, the stored distribution of events includes a log-normal probability distribution of independent random variables, each random variable representing a risk level of a hazard of the operation of the vehicle.

In an embodiment, the stored behavioral model of the operation of the vehicle includes multiple rules of operation. Each rule of operation of the multiple rules of operation has a priority with respect to each other rule of operation of the multiple rules of operation. The priority represents a risk level of the one or more violations of the stored behavioral model.

In an embodiment, a violation of the one or more violations of the stored behavioral model of the operation of the vehicle includes a lateral distance between the vehicle and the one or more objects falling below a threshold lateral distance.

In an embodiment, the priority of the rule of operation is adjusted based on a frequency of the violation.

In an embodiment, a motion planning process of the vehicle is adjusted based on a frequency of the one or more violations of the stored behavioral model to decrease the second risk level.

In an embodiment, a risk level of the motion planning process of the vehicle is determined based on the frequency of the one or more violations of the stored behavioral model.

These and other aspects, features, and implementations can be expressed as methods, apparatus, systems, components, program products, means or steps for performing a function, and in other ways.

These and other aspects, features, and implementations will become apparent from the following descriptions, including the claims.

### BRIEF DESCRIPTION OF THE DRAWINGS

FIG. 1 is a block diagram illustrating an example of an autonomous vehicle (AV) having autonomous capability, in accordance with one or more embodiments.

FIG. 2 is a block diagram illustrating an example “cloud” computing environment, in accordance with one or more embodiments.

FIG. 3 is a block diagram illustrating a computer system, in accordance with one or more embodiments.

FIG. 4 is a block diagram illustrating an example architecture for an AV, in accordance with one or more embodiments.

FIG. 5 is a block diagram illustrating an example of inputs and outputs that may be used by a perception module, in accordance with one or more embodiments.

FIG. 6 is a block diagram illustrating an example of a LiDAR system, in accordance with one or more embodiments.

FIG. 7 is a block diagram illustrating the LiDAR system in operation, in accordance with one or more embodiments.

FIG. 8 is a block diagram illustrating the operation of the LiDAR system in additional detail, in accordance with one or more embodiments.

FIG. 9 is a block diagram illustrating the relationships between inputs and outputs of a planning module, in accordance with one or more embodiments.

FIG. 10 illustrates a directed graph used in path planning, in accordance with one or more embodiments.

FIG. 11 is a block diagram illustrating the inputs and outputs of a control module, in accordance with one or more embodiments.

FIG. 12 is a block diagram illustrating the inputs, outputs, and components of a controller, in accordance with one or more embodiments.

FIG. 13 is a flow diagram illustrating an example process for determining whether a trajectory violates a stored behavioral model of operation of a vehicle, in accordance with one or more embodiments.

FIG. 14 illustrates an example stored behavioral model of operation of a vehicle, in accordance with one or more embodiments.

FIG. 15 illustrates example frequencies of violations of a stored behavioral model of operation of a vehicle, in accordance with one or more embodiments.

FIG. 16 illustrates an example stored behavioral model of operation of a vehicle, in accordance with one or more embodiments.

FIG. 17 illustrates an example stored distribution of events of operation of a vehicle with respect to the one or more objects, in accordance with one or more embodiments.

FIG. 18 illustrates an example stored distribution of events of operation of a vehicle with respect to the one or more objects, in accordance with one or more embodiments.

FIG. 19 illustrates an example stored distribution of events of operation of a vehicle with respect to the one or more objects, in accordance with one or more embodiments.

FIG. 20 illustrates an example stored distribution of events of operation of a vehicle with respect to the one or more objects, in accordance with one or more embodiments.

FIG. 21 illustrates an example stored distribution of events of operation of a vehicle with respect to the one or more objects, in accordance with one or more embodiments.

FIG. 22 is a flow diagram illustrating an example process for vehicle operation using a behavioral rule model, in accordance with one or more embodiments.

FIG. 23 is a flow diagram illustrating an example process for vehicle operation using a behavioral rule model, in accordance with one or more embodiments.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in an embodiment.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:

1. General Overview

2. System Overview

3. Autonomous Vehicle Architecture

4. Autonomous Vehicle Inputs

5. Autonomous Vehicle Planning

6. Autonomous Vehicle Control

7. Autonomous Vehicle Operation Using a Behavioral Rule Model

### General Overview

This document presents methods, systems, and apparatuses for vehicle operation using a behavioral rule model. Road safety is a leading public health issue with over 1 million global road traffic fatalities in 2020 and is currently the seventh leading cause of death in the United States by years of life lost. However, a critical challenge of assessing the impact of road safety interventions is that individual human drivers rarely collide, necessitating data from an unrealistically large amount for driving for a direct comparison of collision rates for different road safety interventions. This issue broadly applies when evaluating any number of policy, technology, or educational interventions to improve road safety. Since human factors are a critical reason for the majority of motor vehicle collisions, methodologies to identify behaviors leading to higher collision risk can create a path towards preventing traffic deaths. In recent years, the challenges of measuring the safety of autonomous vehicles (AVs) relative to a human driving baseline has resurfaced long-standing questions on effectively measuring driving safety. Increasingly, road safety assessment leans on methodologies for other complex, safety-critical systems such as aviation and industrial safety; similarly, new methodologies to assess road safety can apply to other complex systems.

The embodiments disclosed herein implement a rule-based tool to evaluate performance of a machine driver or human driver, evaluate risk factors, and evaluate performance of an AV system or of a subsystem, such as a motion planning module. The implementations of behavior-based driving assessment disclosed here are based on the observations that good drivers consistently follow rules for behavior. Rules derive from safety considerations, traffic laws, or commonly accepted best practices. Driving rule formulation can be used to quantitatively evaluate how actual driving, by either a human or an automated system, matches desirable driving behaviors.

The advantages and benefits of the embodiments described herein include the evaluation of driving performance both for automated vehicle systems and human drivers. Using the embodiments, specific autonomous driving behaviors can be evaluated. Furthermore, the embodiments are useful for insurance companies, which can reward improvements in risk assessment. Moreover, the embodiments disclosed herein can inform a variety of regulatory and standards processes, which are increasingly requiring specific AV behaviors, and to foster industry collaboration on defining good AV driving behaviors.

### System Overview

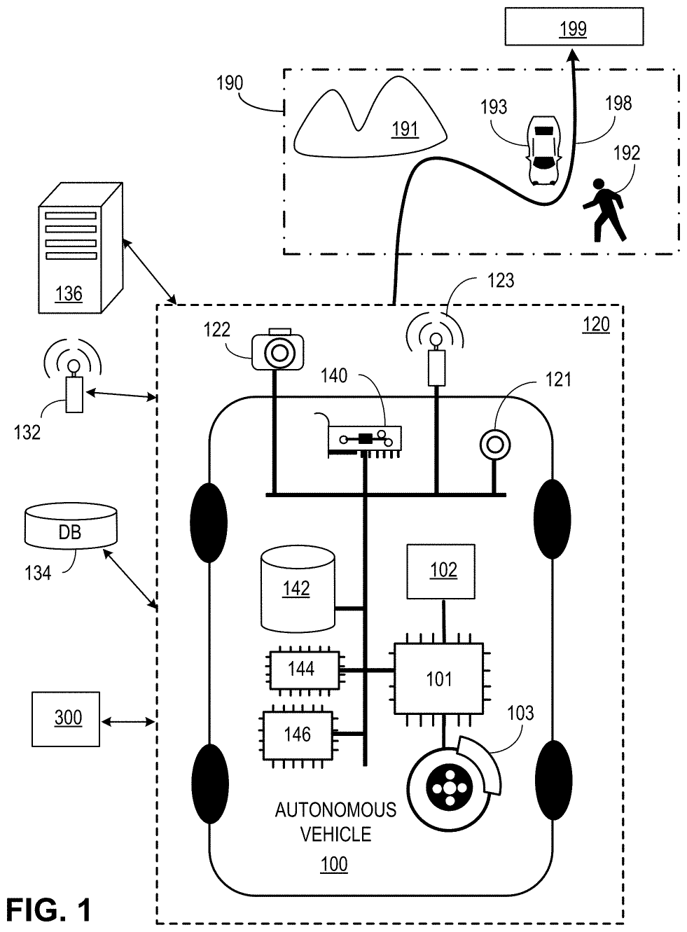

FIG. 1 is a block diagram illustrating an example of an autonomous vehicle 100 having autonomous capability, in accordance with one or more embodiments.

As used herein, the term “autonomous capability” refers to a function, feature, or facility that enables a vehicle to be partially or fully operated without real-time human intervention, including without limitation fully autonomous vehicles, highly autonomous vehicles, and conditionally autonomous vehicles.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, etc. A driverless car is an example of a vehicle.

As used herein, “trajectory” refers to a path or route to operate an AV from a first spatiotemporal location to second spatiotemporal location. In an embodiment, the first spatiotemporal location is referred to as the initial or starting location and the second spatiotemporal location is referred to as the destination, final location, goal, goal position, or goal location. In some examples, a trajectory is made up of one or more segments (e.g., sections of road) and each segment is made up of one or more blocks (e.g., portions of a lane or intersection). In an embodiment, the spatiotemporal locations correspond to real world locations. For example, the spatiotemporal locations are pick up or drop-off locations to pick up or drop-off persons or goods.

As used herein, “sensor(s)” includes one or more hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a RAM and/or a nonvolatile storage), software or firmware components and data processing components such as an ASIC (application-specific integrated circuit), a microprocessor and/or a microcontroller.

As used herein, a “scene description” is a data structure (e.g., list) or data stream that includes one or more classified or labeled objects detected by one or more sensors on the AV vehicle or provided by a source external to the AV.

As used herein, a “road” is a physical area that can be traversed by a vehicle, and may correspond to a named thoroughfare (e.g., city street, interstate freeway, etc.) or may correspond to an unnamed thoroughfare (e.g., a driveway in a house or office building, a section of a parking lot, a section of a vacant lot, a dirt path in a rural area, etc.). Because some vehicles (e.g., 4-wheel-drive pickup trucks, sport utility vehicles, etc.) are capable of traversing a variety of physical areas not specifically adapted for vehicle travel, a “road” may be a physical area not formally defined as a thoroughfare by any municipality or other governmental or administrative body.

As used herein, a “lane” is a portion of a road that can be traversed by a vehicle and may correspond to most or all of the space between lane markings, or may correspond to only some (e.g., less than 50%) of the space between lane markings. For example, a road having lane markings spaced far apart might accommodate two or more vehicles between the markings, such that one vehicle can pass the other without traversing the lane markings, and thus could be interpreted as having a lane narrower than the space between the lane markings or having two lanes between the lane markings. A lane could also be interpreted in the absence of lane markings. For example, a lane may be defined based on physical features of an environment, e.g., rocks and trees along a thoroughfare in a rural area.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “includes,” and/or “including,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

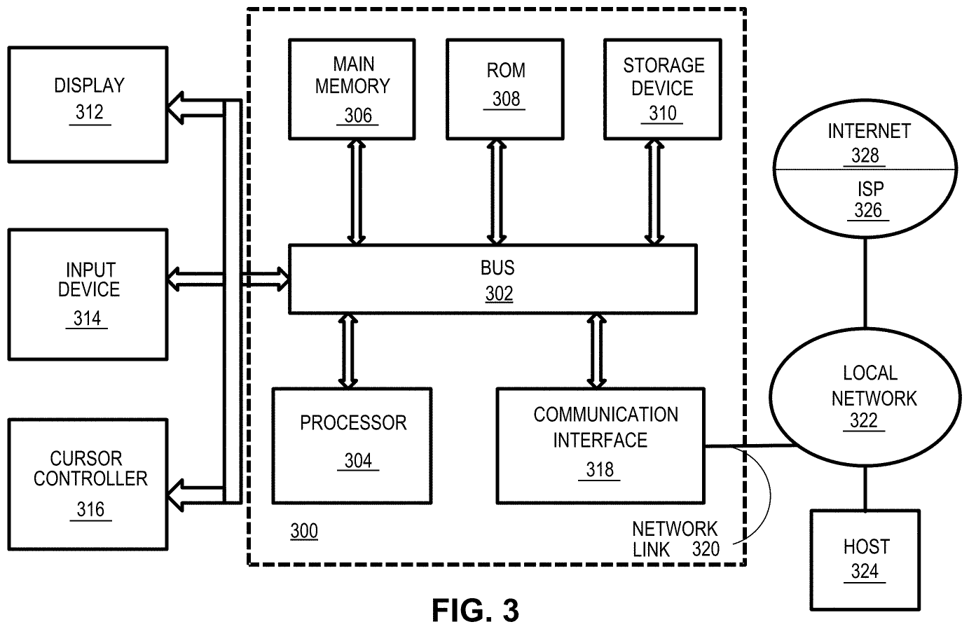

As used herein, an AV system refers to the AV along with the array of hardware, software, stored data, and data generated in real-time that supports the operation of the AV. In an embodiment, the AV system is incorporated within the AV. In an embodiment, the AV system is spread across several locations. For example, some of the software of the AV system is implemented on a cloud computing environment similar to cloud computing environment 300 described below with respect to FIG. 3.

In general, this document describes technologies applicable to any vehicles that have one or more autonomous capabilities including fully autonomous vehicles, highly autonomous vehicles, and conditionally autonomous vehicles, such as so-called Level 5, Level 4 and Level 3 vehicles, respectively (see SAE International's standard J3016: Taxonomy and Definitions for Terms Related to On-Road Motor Vehicle Automated Driving Systems, which is incorporated by reference in its entirety, for more details on the classification of levels of autonomy in vehicles). The technologies described in this document are also applicable to partially autonomous vehicles and driver assisted vehicles, such as so-called Level 2 and Level 1 vehicles (see SAE International's standard J3016: Taxonomy and Definitions for Terms Related to On-Road Motor Vehicle Automated Driving Systems). In an embodiment, one or more of the Level 1, 2, 3, 4 and 5 vehicle systems may automate certain vehicle operations (e.g., steering, braking, and using maps) under certain operating conditions based on processing of sensor inputs. The technologies described in this document can benefit vehicles in any levels, ranging from fully autonomous vehicles to human-operated vehicles.

Referring to FIG. 1, an AV system 120 operates the AV 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

In an embodiment, the AV system 120 includes devices 101 that are instrumented to receive and act on operational commands from the computer processors 146. In an embodiment, computing processors 146 are similar to the processor 304 described below in reference to FIG. 3. Examples of devices 101 include a steering control 102, brakes 103, gears, accelerator pedal or other acceleration control mechanisms, windshield wipers, side-door locks, window controls, and turn-indicators.

In an embodiment, the AV system 120 includes sensors 121 for measuring or inferring properties of state or condition of the AV 100, such as the AV's position, linear velocity and acceleration, angular velocity and acceleration, and heading (e.g., an orientation of the leading end of AV 100). Example of sensors 121 are GNSS, inertial measurement units (IMU) that measure both vehicle linear accelerations and angular rates, wheel sensors for measuring or estimating wheel slip ratios, wheel brake pressure or braking torque sensors, engine torque or wheel torque sensors, and steering angle and angular rate sensors.

In an embodiment, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In an embodiment, the AV system 120 includes a data storage unit 142 and memory 144 for storing machine instructions associated with computer processors 146 or data collected by sensors 121. In an embodiment, the data storage unit 142 is similar to the ROM 308 or storage device 310 described below in relation to FIG. 3. In an embodiment, memory 144 is similar to the main memory 306 described below. In an embodiment, the data storage unit 142 and memory 144 store historical, real-time, and/or predictive information about the environment 190. In an embodiment, the stored information includes maps, driving performance, traffic congestion updates or weather conditions. In an embodiment, data relating to the environment 190 is transmitted to the AV 100 via a communications channel from a remotely located database 134.

In an embodiment, the AV system 120 includes communications devices 140 for communicating measured or inferred properties of other vehicles' states and conditions, such as positions, linear and angular velocities, linear and angular accelerations, and linear and angular headings to the AV 100. These devices include Vehicle-to-Vehicle (V2V) and Vehicle-to-Infrastructure (V2I) communication devices and devices for wireless communications over point-to-point or ad hoc networks or both. In an embodiment, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in an embodiment, one or more other types of communication) is sometimes referred to as Vehicle-to-Everything (V2X) communication. V2X communication typically conforms to one or more communications standards for communication with, between, and among autonomous vehicles.

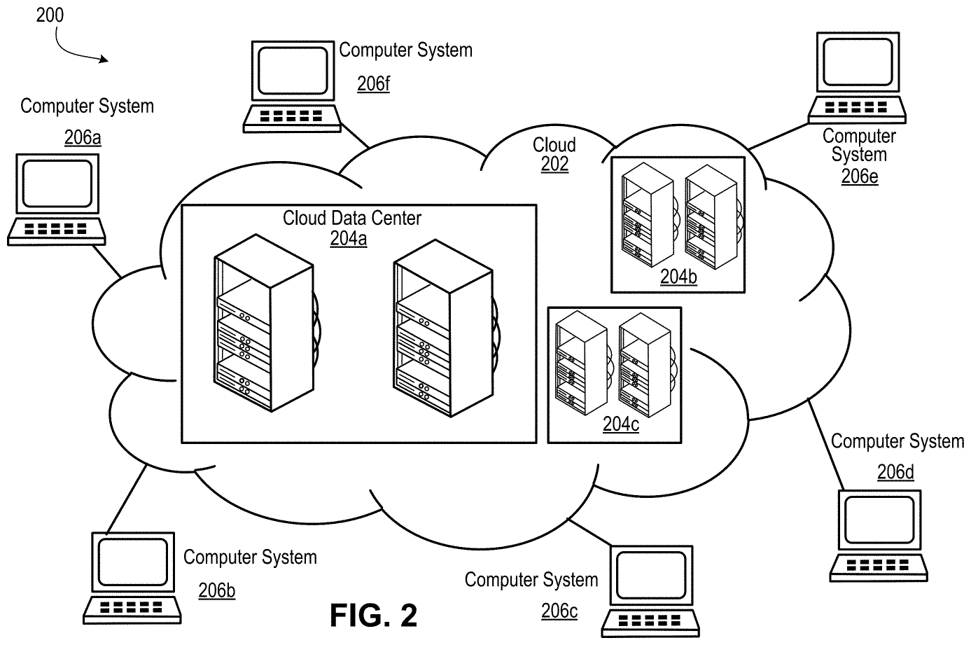

In an embodiment, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In an embodiment, the remotely located database 134 is embedded in a cloud computing environment 200 as described in FIG. 2. The communication interfaces 140 transmit data collected from sensors 121 or other data related to the operation of AV 100 to the remotely located database 134. In an embodiment, communication interfaces 140 transmit information that relates to teleoperations to the AV 100. In an embodiment, the AV 100 communicates with other remote (e.g., “cloud”) servers 136.

In an embodiment, the remotely located database 134 also stores and transmits digital data (e.g., storing data such as road and street locations). Such data is stored on the memory 144 on the AV 100, or transmitted to the AV 100 via a communications channel from the remotely located database 134.

In an embodiment, the remotely located database 134 stores and transmits historical information about driving properties (e.g., speed and acceleration profiles) of vehicles that have previously traveled along trajectory 198 at similar times of day. In one implementation, such data may be stored on the memory 144 on the AV 100, or transmitted to the AV 100 via a communications channel from the remotely located database 134.

Computing devices 146 located on the AV 100 algorithmically generate control actions based on both real-time sensor data and prior information, allowing the AV system 120 to execute its autonomous driving capabilities.

In an embodiment, the AV system 120 includes computer peripherals 132 coupled to computing devices 146 for providing information and alerts to, and receiving input from, a user (e.g., an occupant or a remote user) of the AV 100. In an embodiment, peripherals 132 are similar to the display 312, input device 314, and cursor controller 316 discussed below in reference to FIG. 3. The coupling is wireless or wired. Any two or more of the interface devices may be integrated into a single device.

### Example Cloud Computing Environment

FIG. 2 is a block diagram illustrating an example “cloud” computing environment, in accordance with one or more embodiments. Cloud computing is a model of service delivery for enabling convenient, on-demand network access to a shared pool of configurable computing resources (e.g. networks, network bandwidth, servers, processing, memory, storage, applications, virtual machines, and services). In typical cloud computing systems, one or more large cloud data centers house the machines used to deliver the services provided by the cloud. Referring now to FIG. 2, the cloud computing environment 200 includes cloud data centers 204a, 204b, and 204c that are interconnected through the cloud 202. Data centers 204a, 204b, and 204c provide cloud computing services to computer systems 206a, 206b, 206c, 206d, 206e, and 206f connected to cloud 202.

The cloud computing environment 200 includes one or more cloud data centers. In general, a cloud data center, for example the cloud data center 204a shown in FIG. 2, refers to the physical arrangement of servers that make up a cloud, for example the cloud 202 shown in FIG. 2, or a particular portion of a cloud. For example, servers are physically arranged in the cloud datacenter into rooms, groups, rows, and racks. A cloud datacenter has one or more zones, which include one or more rooms of servers. Each room has one or more rows of servers, and each row includes one or more racks. Each rack includes one or more individual server nodes. In some implementation, servers in zones, rooms, racks, and/or rows are arranged into groups based on physical infrastructure requirements of the datacenter facility, which include power, energy, thermal, heat, and/or other requirements. In an embodiment, the server nodes are similar to the computer system described in FIG. 3. The data center 204a has many computing systems distributed through many racks.

The cloud 202 includes cloud data centers 204a, 204b, and 204c along with the network and networking resources (for example, networking equipment, nodes, routers, switches, and networking cables) that interconnect the cloud data centers 204a, 204b, and 204c and help facilitate the computing systems' 206a-f access to cloud computing services. In an embodiment, the network represents any combination of one or more local networks, wide area networks, or internetworks coupled using wired or wireless links deployed using terrestrial or satellite connections. Data exchanged over the network, is transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols are used at each of the underlying sub-networks. In an embodiment, the network represents one or more interconnected internetworks, such as the public Internet.

The computing systems 206a-f or cloud computing services consumers are connected to the cloud 202 through network links and network adapters. In an embodiment, the computing systems 206a-f are implemented as various computing devices, for example servers, desktops, laptops, tablet, smartphones, Internet of Things (IoT) devices, autonomous vehicles (including, cars, drones, shuttles, trains, buses, etc.) and consumer electronics. In an embodiment, the computing systems 206a-f are implemented in or as a part of other systems.

### Computer System

FIG. 3 is a block diagram illustrating a computer system 300, in accordance with one or more embodiments. In an implementation, the computer system 300 is a special purpose computing device. The special-purpose computing device is hard-wired to perform the techniques or includes digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In an embodiment, the computer system 300 includes a bus 302 or other communication mechanism for communicating information, and a hardware processor 304 coupled with a bus 302 for processing information. The hardware processor 304 is, for example, a general-purpose microprocessor. The computer system 300 also includes a main memory 306, such as a random-access memory (RAM) or other dynamic storage device, coupled to the bus 302 for storing information and instructions to be executed by processor 304. In one implementation, the main memory 306 is used for storing temporary variables or other intermediate information during execution of instructions to be executed by the processor 304. Such instructions, when stored in non-transitory storage media accessible to the processor 304, render the computer system 300 into a special-purpose machine that is customized to perform the operations specified in the instructions.

In an embodiment, the computer system 300 further includes a read only memory (ROM) 308 or other static storage device coupled to the bus 302 for storing static information and instructions for the processor 304. A storage device 310, such as a magnetic disk, optical disk, solid-state drive, or three-dimensional cross point memory is provided and coupled to the bus 302 for storing information and instructions.

In an embodiment, the computer system 300 is coupled via the bus 302 to a display 312, such as a cathode ray tube (CRT), a liquid crystal display (LCD), plasma display, light emitting diode (LED) display, or an organic light emitting diode (OLED) display for displaying information to a computer user. An input device 314, including alphanumeric and other keys, is coupled to bus 302 for communicating information and command selections to the processor 304. Another type of user input device is a cursor controller 316, such as a mouse, a trackball, a touch-enabled display, or cursor direction keys for communicating direction information and command selections to the processor 304 and for controlling cursor movement on the display 312. This input device typically has two degrees of freedom in two axes, a first axis (e.g., x-axis) and a second axis (e.g., y-axis), that allows the device to specify positions in a plane.

According to one embodiment, the techniques herein are performed by the computer system 300 in response to the processor 304 executing one or more sequences of one or more instructions contained in the main memory 306. Such instructions are read into the main memory 306 from another storage medium, such as the storage device 310. Execution of the sequences of instructions contained in the main memory 306 causes the processor 304 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 310. Volatile media includes dynamic memory, such as the main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that include the bus 302. Transmission media can also take the form of acoustic or light waves, such as those generated during radio-wave and infrared data communications.

In an embodiment, various forms of media are involved in carrying one or more sequences of one or more instructions to the processor 304 for execution. For example, the instructions are initially carried on a magnetic disk or solid-state drive of a remote computer. The remote computer loads the instructions into its dynamic memory and send the instructions over a telephone line using a modem. A modem local to the computer system 300 receives the data on the telephone line and use an infrared transmitter to convert the data to an infrared signal. An infrared detector receives the data carried in the infrared signal and appropriate circuitry places the data on the bus 302. The bus 302 carries the data to the main memory 306, from which processor 304 retrieves and executes the instructions. The instructions received by the main memory 306 may optionally be stored on the storage device 310 either before or after execution by processor 304.

The computer system 300 also includes a communication interface 318 coupled to the bus 302. The communication interface 318 provides a two-way data communication coupling to a network link 320 that is connected to a local network 322. For example, the communication interface 318 is an integrated service digital network (ISDN) card, cable modem, satellite modem, or a modem to provide a data communication connection to a corresponding type of telephone line. As another example, the communication interface 318 is a local area network (LAN) card to provide a data communication connection to a compatible LAN. In some implementations, wireless links are also implemented. In any such implementation, the communication interface 318 sends and receives electrical, electromagnetic, or optical signals that carry digital data streams representing various types of information.

The network link 320 typically provides data communication through one or more networks to other data devices. For example, the network link 320 provides a connection through the local network 322 to a host computer 324 or to a cloud data center or equipment operated by an Internet Service Provider (ISP) 326. The ISP 326 in turn provides data communication services through the world-wide packet data communication network now commonly referred to as the “Internet” 328. The local network 322 and Internet 328 both use electrical, electromagnetic, or optical signals that carry digital data streams. The signals through the various networks and the signals on the network link 320 and through the communication interface 318, which carry the digital data to and from the computer system 300, are example forms of transmission media. In an embodiment, the network 320 contains the cloud 202 or a part of the cloud 202 described above.

The computer system 300 sends messages and receives data, including program code, through the network(s), the network link 320, and the communication interface 318. In an embodiment, the computer system 300 receives code for processing. The received code is executed by the processor 304 as it is received, and/or stored in storage device 310, or other non-volatile storage for later execution.

### Autonomous Vehicle Architecture

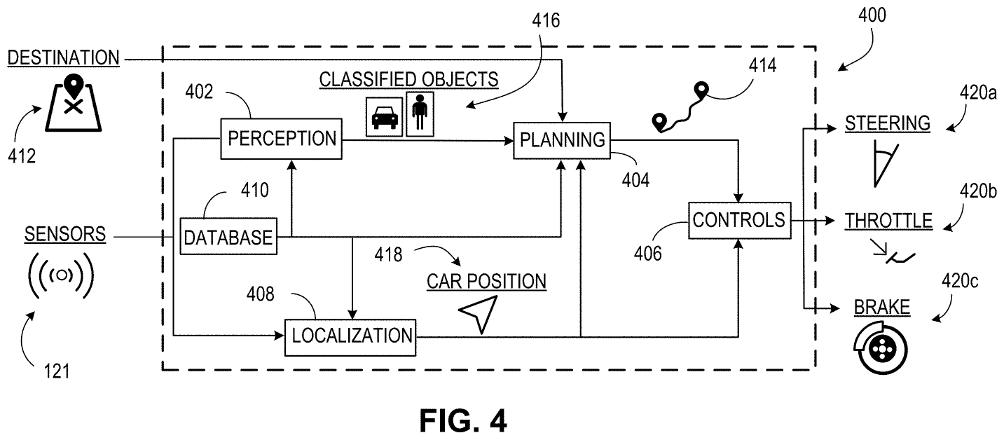

FIG. 4 is a block diagram illustrating an example architecture 400 for an autonomous vehicle (e.g., the AV 100 shown in FIG. 1), in accordance with one or more embodiments. The architecture 400 includes a perception module 402 (sometimes referred to as a perception circuit), a planning module 404 (sometimes referred to as a planning circuit), a control module 406 (sometimes referred to as a control circuit), a localization module 408 (sometimes referred to as a localization circuit), and a database module 410 (sometimes referred to as a database circuit). Each module plays a role in the operation of the AV 100. Together, the modules 402, 404, 406, 408, and 410 may be part of the AV system 120 shown in FIG. 1. In an embodiment, any of the modules 402, 404, 406, 408, and 410 is a combination of computer software (e.g., executable code stored on a computer-readable medium) and computer hardware (e.g., one or more microprocessors, microcontrollers, application-specific integrated circuits [ASICs]), hardware memory devices, other types of integrated circuits, other types of computer hardware, or a combination of any or all of these things).

In use, the planning module 404 receives data representing a destination 412 and determines data representing a trajectory 414 (sometimes referred to as a route) that can be traveled by the AV 100 to reach (e.g., arrive at) the destination 412. In order for the planning module 404 to determine the data representing the trajectory 414, the planning module 404 receives data from the perception module 402, the localization module 408, and the database module 410.

The perception module 402 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 416 is provided to the planning module 404.

The planning module 404 also receives data representing the AV position 418 from the localization module 408. The localization module 408 determines the AV position by using data from the sensors 121 and data from the database module 410 (e.g., a geographic data) to calculate a position. For example, the localization module 408 uses data from a global navigation satellite system (GNSS) unit and geographic data to calculate a longitude and latitude of the AV. In an embodiment, data used by the localization module 408 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types.

The control module 406 receives the data representing the trajectory 414 and the data representing the AV position 418 and operates the control functions 420a-c (e.g., steering, throttling, braking, ignition) of the AV in a manner that will cause the AV 100 to travel the trajectory 414 to the destination 412. For example, if the trajectory 414 includes a left turn, the control module 406 will operate the control functions 420a-c in a manner such that the steering angle of the steering function will cause the AV 100 to turn left and the throttling and braking will cause the AV 100 to pause and wait for passing pedestrians or vehicles before the turn is made.

### Autonomous Vehicle Inputs

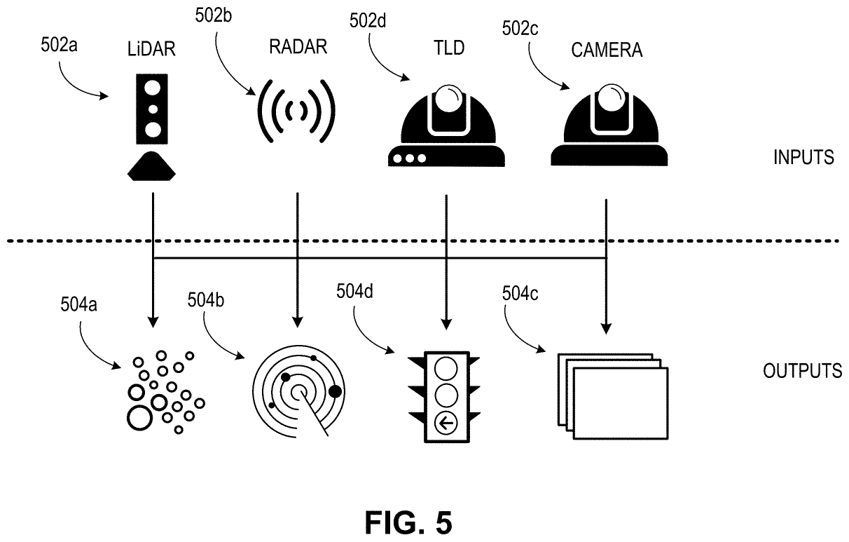

FIG. 5 is a block diagram illustrating an example of inputs 502a-d (e.g., sensors 121 shown in FIG. 1) and outputs 504a-d (e.g., sensor data) that is used by the perception module 402 (FIG. 4), in accordance with one or more embodiments. One input 502a is a LiDAR (Light Detection and Ranging) system (e.g., LiDAR 123 shown in FIG. 1). LiDAR is a technology that uses light (e.g., bursts of light such as infrared light) to obtain data about physical objects in its line of sight. A LiDAR system produces LiDAR data as output 504a. For example, LiDAR data is collections of 3D or 2D points (also known as a point clouds) that are used to construct a representation of the environment 190.

Another input 502b is a RADAR system. RADAR is a technology that uses radio waves to obtain data about nearby physical objects. RADARs can obtain data about objects not within the line of sight of a LiDAR system. A RADAR system 502b produces RADAR data as output 504b. For example, RADAR data are one or more radio frequency electromagnetic signals that are used to construct a representation of the environment 190.

Another input 502c is a camera system. A camera system uses one or more cameras (e.g., digital cameras using a light sensor such as a charge-coupled device [CCD]) to obtain information about nearby physical objects. A camera system produces camera data as output 504c. Camera data often takes the form of image data (e.g., data in an image data format such as RAW, JPEG, PNG, etc.). In some examples, the camera system has multiple independent cameras, e.g., for the purpose of stereopsis (stereo vision), which enables the camera system to perceive depth. Although the objects perceived by the camera system are described here as “nearby,” this is relative to the AV. In use, the camera system may be configured to “see” objects far, e.g., up to a kilometer or more ahead of the AV. Accordingly, the camera system may have features such as sensors and lenses that are optimized for perceiving objects that are far away.

Another input 502d is a traffic light detection (TLD) system. A TLD system uses one or more cameras to obtain information about traffic lights, street signs, and other physical objects that provide visual operation information. A TLD system produces TLD data as output 504d. TLD data often takes the form of image data (e.g., data in an image data format such as RAW, JPEG, PNG, etc.). A TLD system differs from a system incorporating a camera in that a TLD system uses a camera with a wide field of view (e.g., using a wide-angle lens or a fish-eye lens) in order to obtain information about as many physical objects providing visual operation information as possible, so that the AV 100 has access to all relevant operation information provided by these objects. For example, the viewing angle of the TLD system may be about 120 degrees or more.

In an embodiment, outputs 504a-d are combined using a sensor fusion technique. Thus, either the individual outputs 504a-d are provided to other systems of the AV 100 (e.g., provided to a planning module 404 as shown in FIG. 4), or the combined output can be provided to the other systems, either in the form of a single combined output or multiple combined outputs of the same type (e.g., using the same combination technique or combining the same outputs or both) or different types type (e.g., using different respective combination techniques or combining different respective outputs or both). In an embodiment, an early fusion technique is used. An early fusion technique is characterized by combining outputs before one or more data processing steps are applied to the combined output. In an embodiment, a late fusion technique is used. A late fusion technique is characterized by combining outputs after one or more data processing steps are applied to the individual outputs.

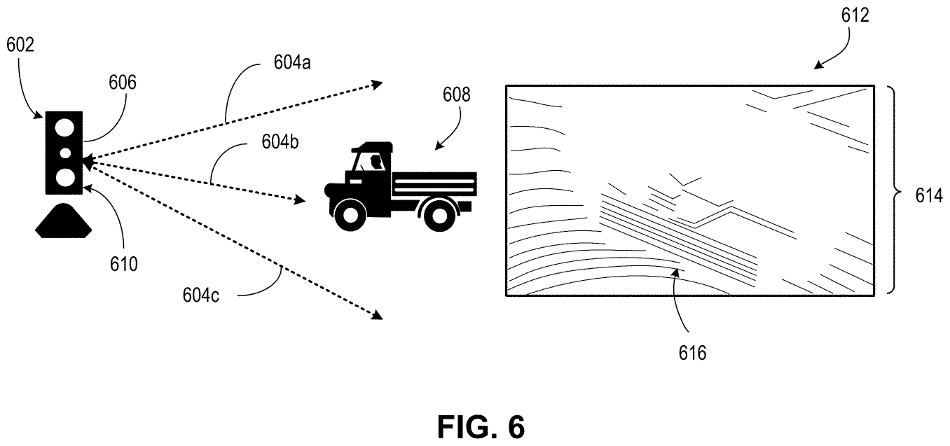

FIG. 6 is a block diagram illustrating an example of a LiDAR system 602 (e.g., the input 502a shown in FIG. 5), in accordance with one or more embodiments. The LiDAR system 602 emits light 604a-c from a light emitter 606 (e.g., a laser transmitter). Light emitted by a LiDAR system is typically not in the visible spectrum; for example, infrared light is often used. Some of the light 604b emitted encounters a physical object 608 (e.g., a vehicle) and reflects back to the LiDAR system 602. (Light emitted from a LiDAR system typically does not penetrate physical objects, e.g., physical objects in solid form.) The LiDAR system 602 also has one or more light detectors 610, which detect the reflected light. In an embodiment, one or more data processing systems associated with the LiDAR system generates an image 612 representing the field of view 614 of the LiDAR system. The image 612 includes information that represents the boundaries 616 of a physical object 608. In this way, the image 612 is used to determine the boundaries 616 of one or more physical objects near an AV.

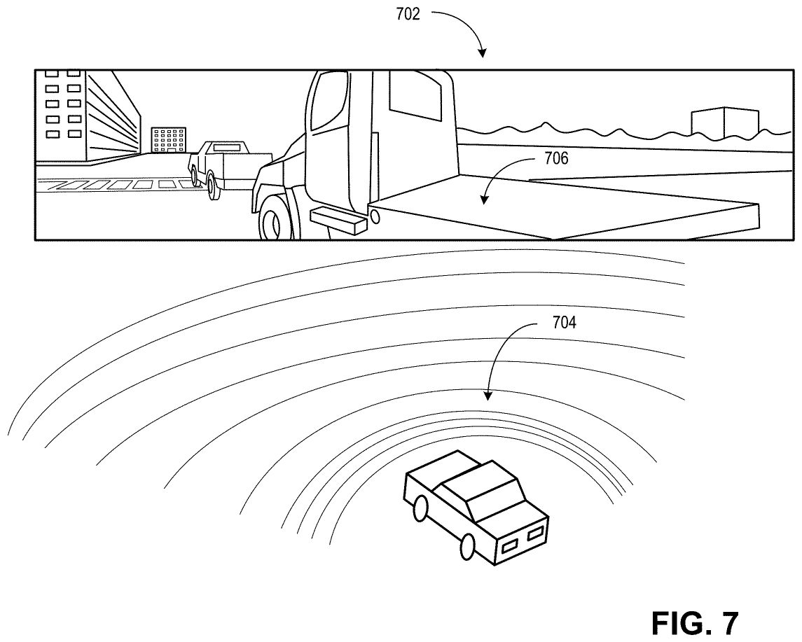

FIG. 7 is a block diagram illustrating the LiDAR system 602 in operation, in accordance with one or more embodiments. In the scenario shown in this figure, the AV 100 receives both camera system output 504c in the form of an image 702 and LiDAR system output 504a in the form of LiDAR data points 704. In use, the data processing systems of the AV 100 compares the image 702 to the data points 704. In particular, a physical object 706 identified in the image 702 is also identified among the data points 704. In this way, the AV 100 perceives the boundaries of the physical object based on the contour and density of the data points 704.

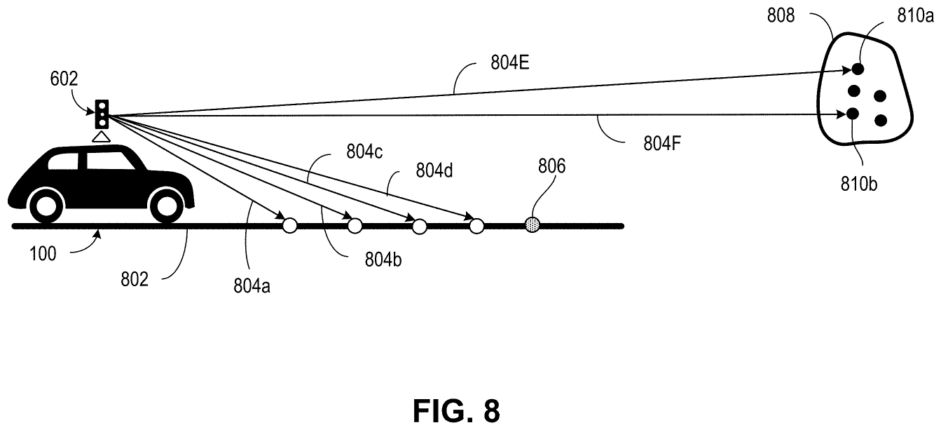

FIG. 8 is a block diagram illustrating the operation of the LiDAR system 602 in additional detail, in accordance with one or more embodiments. As described above, the AV 100 detects the boundary of a physical object based on characteristics of the data points detected by the LiDAR system 602. As shown in FIG. 8, a flat object, such as the ground 802, will reflect light 804a-d emitted from a LiDAR system 602 in a consistent manner. Put another way, because the LiDAR system 602 emits light using consistent spacing, the ground 802 will reflect light back to the LiDAR system 602 with the same consistent spacing. As the AV 100 travels over the ground 802, the LiDAR system 602 will continue to detect light reflected by the next valid ground point 806 if nothing is obstructing the road. However, if an object 808 obstructs the road, light 804e-f emitted by the LiDAR system 602 will be reflected from points 810a-b in a manner inconsistent with the expected consistent manner. From this information, the AV 100 can determine that the object 808 is present.

### Path Planning

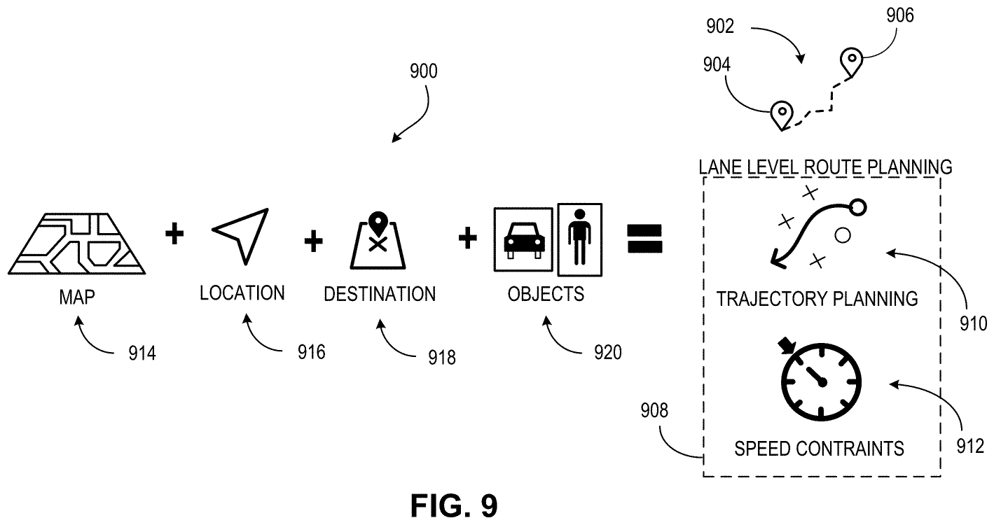

FIG. 9 is a block diagram 900 illustrating of the relationships between inputs and outputs of a planning module 404 (e.g., as shown in FIG. 4), in accordance with one or more embodiments. In general, the output of a planning module 404 is a route 902 from a start point 904 (e.g., source location or initial location), and an end point 906 (e.g., destination or final location). The route 902 is typically defined by one or more segments. For example, a segment is a distance to be traveled over at least a portion of a street, road, highway, driveway, or other physical area appropriate for automobile travel. In some examples, e.g., if the AV 100 is an off-road capable vehicle such as a four-wheel-drive (4WD) or all-wheel-drive (AWD) car, SUV, pick-up truck, or the like, the route 902 includes “off-road” segments such as unpaved paths or open fields.

In addition to the route 902, a planning module also outputs lane-level route planning data 908. The lane-level route planning data 908 is used to traverse segments of the route 902 based on conditions of the segment at a particular time. For example, if the route 902 includes a multi-lane highway, the lane-level route planning data 908 includes trajectory planning data 910 that the AV 100 can use to choose a lane among the multiple lanes, e.g., based on whether an exit is approaching, whether one or more of the lanes have other vehicles, or other factors that vary over the course of a few minutes or less. Similarly, in some implementations, the lane-level route planning data 908 includes speed constraints 912 specific to a segment of the route 902. For example, if the segment includes pedestrians or un-expected traffic, the speed constraints 912 may limit the AV 100 to a travel speed slower than an expected speed, e.g., a speed based on speed limit data for the segment.

In an embodiment, the inputs to the planning module 404 includes database data 914 (e.g., from the database module 410 shown in FIG. 4), current location data 916 (e.g., the AV position 418 shown in FIG. 4), destination data 918 (e.g., for the destination 412 shown in FIG. 4), and object data 920 (e.g., the classified objects 416 as perceived by the perception module 402 as shown in FIG. 4). In an embodiment, the database data 914 includes rules used in planning. Rules are specified using a formal language, e.g., using Boolean logic. In any given situation encountered by the AV 100, at least some of the rules will apply to the situation. A rule applies to a given situation if the rule has conditions that are met based on information available to the AV 100, e.g., information about the surrounding environment. Rules can have priority. For example, a rule that says, “if the road is a freeway, move to the leftmost lane” can have a lower priority than “if the exit is approaching within a mile, move to the rightmost lane.”

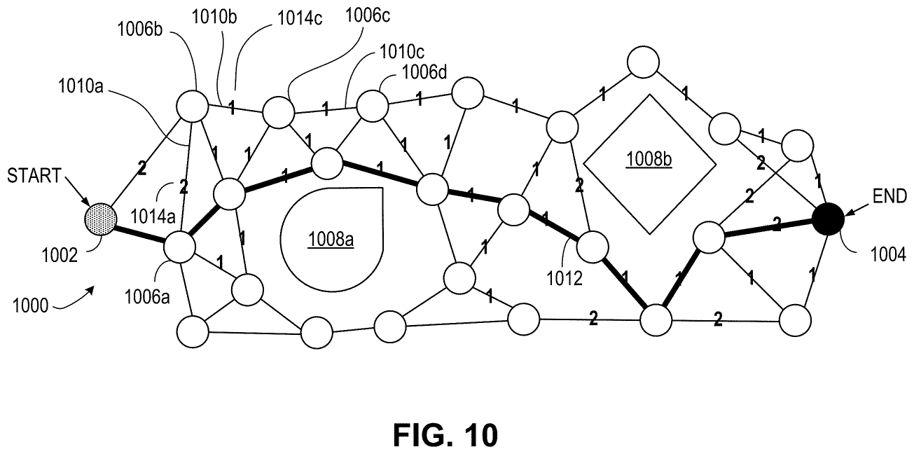

FIG. 10 illustrates a directed graph 1000 used in path planning, e.g., by the planning module 404 (FIG. 4), in accordance with one or more embodiments. In general, a directed graph 1000 like the one shown in FIG. 10 is used to determine a path between any start point 1002 and end point 1004. In real-world terms, the distance separating the start point 1002 and end point 1004 may be relatively large (e.g., in two different metropolitan areas) or may be relatively small (e.g., two intersections abutting a city block or two lanes of a multi-lane road).

In an embodiment, the directed graph 1000 has nodes 1006a-d representing different locations between the start point 1002 and the end point 1004 that could be occupied by an AV 100. In some examples, e.g., when the start point 1002 and end point 1004 represent different metropolitan areas, the nodes 1006a-d represent segments of roads. In some examples, e.g., when the start point 1002 and the end point 1004 represent different locations on the same road, the nodes 1006a-d represent different positions on that road. In this way, the directed graph 1000 includes information at varying levels of granularity. In an embodiment, a directed graph having high granularity is also a subgraph of another directed graph having a larger scale. For example, a directed graph in which the start point 1002 and the end point 1004 are far away (e.g., many miles apart) has most of its information at a low granularity and is based on stored data, but also includes some high granularity information for the portion of the graph that represents physical locations in the field of view of the AV 100.

The nodes 1006a-d are distinct from objects 1008a-b which cannot overlap with a node. In an embodiment, when granularity is low, the objects 1008a-b represent regions that cannot be traversed by automobile, e.g., areas that have no streets or roads. When granularity is high, the objects 1008a-b represent physical objects in the field of view of the AV 100, e.g., other automobiles, pedestrians, or other entities with which the AV 100 cannot share physical space. In an embodiment, some or all of the objects 1008a-b are static objects (e.g., an object that does not change position such as a street lamp or utility pole) or dynamic objects (e.g., an object that is capable of changing position such as a pedestrian or other car).

The nodes 1006a-d are connected by edges 1010a-c. If two nodes 1006a-b are connected by an edge 1010a, it is possible for an AV 100 to travel between one node 1006a and the other node 1006b, e.g., without having to travel to an intermediate node before arriving at the other node 1006b. (When we refer to an AV 100 traveling between nodes, we mean that the AV 100 travels between the two physical positions represented by the respective nodes.) The edges 1010a-c are often bidirectional, in the sense that an AV 100 travels from a first node to a second node, or from the second node to the first node. In an embodiment, edges 1010a-c are unidirectional, in the sense that an AV 100 can travel from a first node to a second node, however the AV 100 cannot travel from the second node to the first node. Edges 1010a-c are unidirectional when they represent, for example, one-way streets, individual lanes of a street, road, or highway, or other features that can only be traversed in one direction due to legal or physical constraints.

In an embodiment, the planning module 404 uses the directed graph 1000 to identify a path 1012 made up of nodes and edges between the start point 1002 and end point 1004.

An edge 1010a-c has an associated cost 1014a-b. The cost 1014a-b is a value that represents the resources that will be expended if the AV 100 chooses that edge. A typical resource is time. For example, if one edge 1010a represents a physical distance that is twice that as another edge 1010b, then the associated cost 1014a of the first edge 1010a may be twice the associated cost 1014b of the second edge 1010b. Other factors that affect time include expected traffic, number of intersections, speed limit, etc. Another typical resource is fuel economy. Two edges 1010a-b may represent the same physical distance, but one edge 1010a may require more fuel than another edge 1010b, e.g., because of road conditions, expected weather, etc.

When the planning module 404 identifies a path 1012 between the start point 1002 and end point 1004, the planning module 404 typically chooses a path optimized for cost, e.g., the path that has the least total cost when the individual costs of the edges are added together.

### Autonomous Vehicle Control

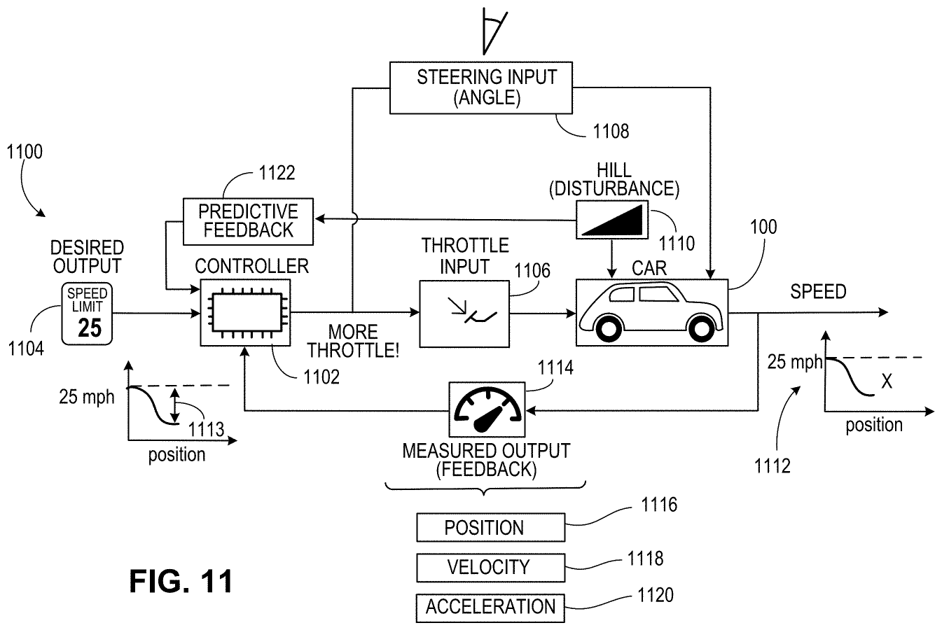

FIG. 11 is a block diagram 1100 illustrating the inputs and outputs of a control module 406 (e.g., as shown in FIG. 4), in accordance with one or more embodiments. A control module operates in accordance with a controller 1102 which includes, for example, one or more processors (e.g., one or more computer processors such as microprocessors or microcontrollers or both) similar to processor 304, short-term and/or long-term data storage (e.g., memory random-access memory or flash memory or both) similar to main memory 306, ROM 1308, and storage device 210, and instructions stored in memory that carry out operations of the controller 1102 when the instructions are executed (e.g., by the one or more processors).

In an embodiment, the controller 1102 receives data representing a desired output 1104. The desired output 1104 typically includes a velocity, e.g., a speed and a heading. The desired output 1104 can be based on, for example, data received from a planning module 404 (e.g., as shown in FIG. 4). In accordance with the desired output 1104, the controller 1102 produces data usable as a throttle input 1106 and a steering input 1108. The throttle input 1106 represents the magnitude in which to engage the throttle (e.g., acceleration control) of an AV 100, e.g., by engaging the steering pedal, or engaging another throttle control, to achieve the desired output 1104. In some examples, the throttle input 1106 also includes data usable to engage the brake (e.g., deceleration control) of the AV 100. The steering input 1108 represents a steering angle, e.g., the angle at which the steering control (e.g., steering wheel, steering angle actuator, or other functionality for controlling steering angle) of the AV should be positioned to achieve the desired output 1104.

In an embodiment, the controller 1102 receives feedback that is used in adjusting the inputs provided to the throttle and steering. For example, if the AV 100 encounters a disturbance 1110, such as a hill, the measured speed 1112 of the AV 100 is lowered below the desired output speed. In an embodiment, any measured output 1114 is provided to the controller 1102 so that the necessary adjustments are performed, e.g., based on the differential 1113 between the measured speed and desired output. The measured output 1114 includes measured position 1116, measured velocity 1118, (including speed and heading), measured acceleration 1120, and other outputs measurable by sensors of the AV 100.

In an embodiment, information about the disturbance 1110 is detected in advance, e.g., by a sensor such as a camera or LiDAR sensor, and provided to a predictive feedback module 1122. The predictive feedback module 1122 then provides information to the controller 1102 that the controller 1102 can use to adjust accordingly. For example, if the sensors of the AV 100 detect (“see”) a hill, this information can be used by the controller 1102 to prepare to engage the throttle at the appropriate time to avoid significant deceleration.

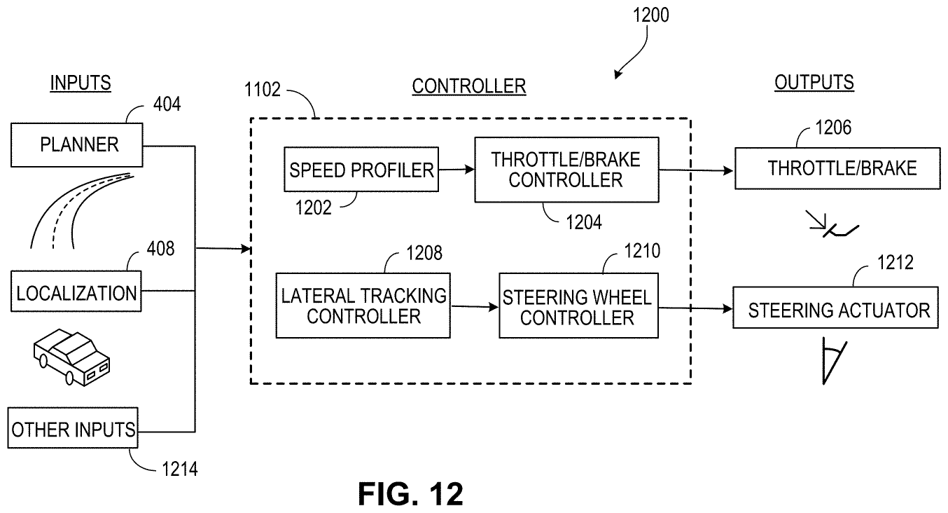

FIG. 12 is a block diagram 1200 illustrating the inputs, outputs, and components of the controller 1102, in accordance with one or more embodiments. The controller 1102 has a speed profiler 1202 which affects the operation of a throttle/brake controller 1204. For example, the speed profiler 1202 instructs the throttle/brake controller 1204 to engage acceleration or engage deceleration using the throttle/brake 1206 depending on, e.g., feedback received by the controller 1102 and processed by the speed profiler 1202.

The controller 1102 also has a lateral tracking controller 1208 which affects the operation of a steering controller 1210. For example, the lateral tracking controller 1208 instructs the steering controller 1204 to adjust the position of the steering angle actuator 1212 depending on, e.g., feedback received by the controller 1102 and processed by the lateral tracking controller 1208.

The controller 1102 receives several inputs used to determine how to control the throttle/brake 1206 and steering angle actuator 1212. A planning module 404 provides information used by the controller 1102, for example, to choose a heading when the AV 100 begins operation and to determine which road segment to traverse when the AV 100 reaches an intersection. A localization module 408 provides information to the controller 1102 describing the current location of the AV 100, for example, so that the controller 1102 can determine if the AV 100 is at a location expected based on the manner in which the throttle/brake 1206 and steering angle actuator 1212 are being controlled. In an embodiment, the controller 1102 receives information from other inputs 1214, e.g., information received from databases, computer networks, etc.

### Vehicle Operation Using a Behavioral Rule Model

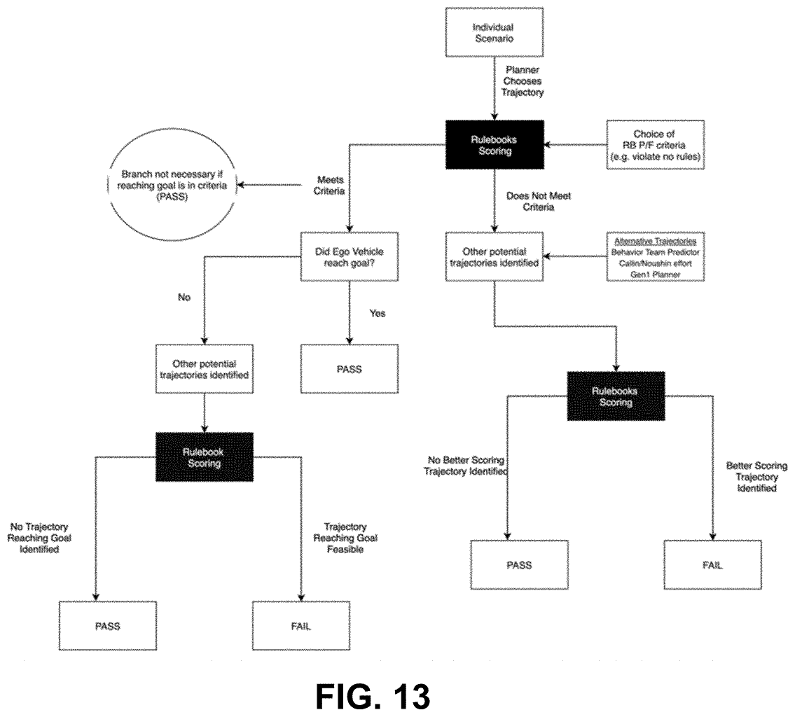

FIG. 13 is a flow diagram illustrating a process for determining whether a trajectory violates a stored behavioral model of operation of the AV 100, in accordance with one or more embodiments. The AV 100 is illustrated and described in more detail with reference to FIG. 1. The AV 100 uses a stored behavioral model of the operation of the AV 100 to provide feedback on the AV driving performance. The stored behavioral model is sometimes referred to as a rulebook. In some embodiments, the feedback is provided in a pass-fail manner. The process of FIG. 13 is designed to identify when the AV 100 generates a rule-violating trajectory, when a materially-better trajectory than the one generated was available to the AV 100, and the preferable trajectory.

The AV 100 operates in an environment 190. The environment 190 is illustrated and described in more detail with reference to FIG. 1. In an embodiment, one or more processors 146 of the AV 100 generate a trajectory 198. The processor 146 and trajectory 198 are illustrated and described in more detail with reference to FIG. 1. The trajectory 198 is generated based on first sensor data from a first set of sensors (e.g., sensors 121) of the AV 100 and second sensor data from a second set of sensors (e.g., sensors 122) of the AV 100. The sensors 121, 122 are illustrated and described in more detail with reference to FIG. 1. The first sensor data represents operation of the AV 100 and the second sensor data represents one or more objects 146 located in the environment 190. The objects are illustrated and described in more detail with reference to FIG. 4. In an embodiment, the first set of sensors 121 include at least one of an accelerometer, a steering wheel angle sensor, a wheel sensor, or a brake sensor. The first sensor data includes at least one of a speed of the vehicle, an acceleration of the vehicle, a heading of the vehicle, an angular velocity of the vehicle, or a torque of the vehicle.

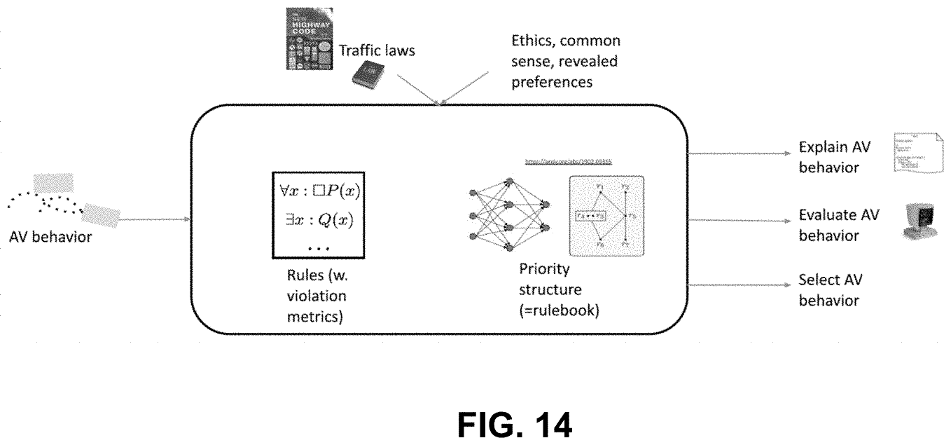

In an embodiment, the one or more processors determine whether the trajectory 198 causes one or more violations of a stored behavioral model of the operation of the AV 100. An example stored behavioral model is illustrated and described in more detail with reference to FIG. 14. The one or more violations are determined with respect to the one or more objects 416 located in the environment 190. For example, criteria are defined for flagging a trajectory 198 as potentially failing. A simple criterion is violation of a single rule, and other formulations are also possible. For example, given a potential or actual trajectory 198 generated by the planning module 404 of the AV 100, the process of FIG. 13 provides feedback on the trajectory 198 in terms of the appropriateness of the driving behavior. The planning module 404 is illustrated and described in more detail with reference to FIG. 4.

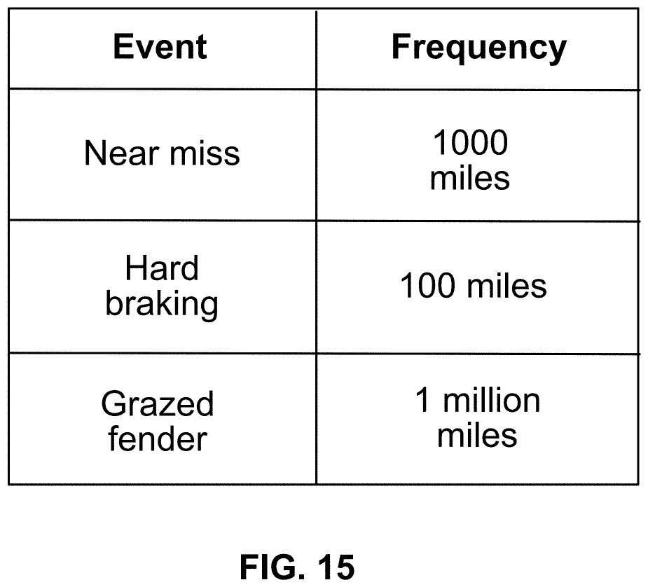

In an embodiment, responsive to determining that the trajectory 198 causes the one or more violations of the stored behavioral model, the one or more processors 146 determine a first risk level of the one or more violations based on a stored distribution of events of the operation of the AV 100 with respect to the one or more objects 416. The events are sometimes referred to as “hazards. The stored distribution of events is illustrated and described in more detail with reference to FIG. 15. The one or more processors 146 generate an alternative trajectory for the AV 100. For example, a set of alternative trajectories are created to assess against the flagged trajectory 198.

In an embodiment, the one or more processors 146 determine that the alternative trajectory has a second risk level higher than the first risk level. The second risk level is determined with respect to the one or more objects 416. For example, the potential results of the feedback from risk determination are “PASS,” i.e., the trajectory 198 is either satisfactory, or a better alternative trajectory is not available, or “FAIL,” i.e., the AV trajectory 198 does not conform to rulebook behavioral specifications and there are materially better alternative trajectories available. The trajectory 198 is deemed “FAIL” if a materially better trajectory is identified. A formalization of what constitutes a materially better trajectory is used. The process of FIG. 13 is not used to identify marginal or trivial improvements.

The process of FIG. 13 is designed to prevent “trivially satisfying” trajectories, i.e., trajectories where the AV 100 comes to a stop or does not reach its goal, from being deemed a better solution than a trajectory 198 that reaches the goal with some rule violations. A rule to “reach goal” is explicitly built into rulebooks. The one or more processors 146 operate the AV 100 based on the trajectory 198 to avoid a collision of the AV 100 and the one or more objects 416. For example, the control module 406, illustrated and described in more detail with reference to FIG. 4, operates the AV 100.

FIG. 14 illustrates a stored behavioral model of operation of the AV 100, in accordance with one or more embodiments. The AV 100 is illustrated and described in more detail with reference to FIG. 1. In an embodiment, one or more processors 146 of the AV 100 receive first sensor data from a first set of sensors 121 of the AV 100 and second sensor data from a second set of sensors 122 of the AV 100. The processors 146 and sensors 121, 122 are illustrated and described in more detail with reference to FIG. 1. The first sensor data represents operation of the AV 100 and the second sensor data represents one or more objects 416 located in the environment 190. The objects 416 are illustrated and described in more detail with reference to FIG. 4. The environment 190 is illustrated and described in more detail with reference to FIG. 1. In an embodiment, the second set of sensors 122 include at least one of a LiDAR, a RADAR, a camera, and a microphone. The second sensor data includes at least one of an image of the one or more objects 416, a speed of the one or more objects 416, an acceleration of the one or more objects 416, or a lateral distance between the one or more objects 416 and the AV 100.

In an embodiment, the one or more processors 146 determine one or more violations of a stored behavioral model of the operation of the AV 100 based on the first sensor data and the second sensor data. The one or more violations are determined with respect to the one or more objects 416 located in the environment 190. For example, vehicle-based or external sensors, such those configured on the AV 100, record information on the scenarios the AV 100 is involved with and the driver's responding driving behaviors, including, but not limited to speed, heading, neighboring objects, or routes.

In an embodiment, the one or more processors 146 determine a first risk level of the one or more violations based on a stored distribution of events of the operation of the AV 100 with respect to the one or more objects 416. An example stored distribution of events is illustrated and described in more detail with reference to FIG. 15. For example, given the recordings, rulebooks (rule formulation and rule evaluation) are used to determine if the driving behavior follows or violates rules. Rule violations can be correlated with safety outcomes in both humans and automated driving systems.

Responsive to the first risk level being greater than a threshold risk level, the one or more processors generate a trajectory 198 for the AV 100. The trajectory 198 is illustrated and described in more detail with reference to FIG. 1. The trajectory has a second risk level lower than the threshold risk level. The second risk level is determined with respect to the one or more objects 416. The one or more processors 146 operate the AV 100 based on the trajectory 198 to avoid a collision of the AV 100 and the one or more objects 416.

In an embodiment, a motion planning process of the planning module 404 is adjusted based on a frequency of the one or more violations of the stored behavioral model to decrease the second risk level. For example, a validated rulebook is applied to design and implement automated vehicle systems or perform “risk scoring” of human drivers for insurance or public safety purposes. In the case of machine drivers, which usually have system models, the driving performance can evaluate AV driving performance using rulebooks. In an embodiment, a risk level of the motion planning process of the AV 100 is determined based on the frequency of the one or more violations of the stored behavioral model. For example, the effects of system design and subsystem performance on planned trajectories are modeled as shown in FIG. 14. Planned trajectories are scored to measure overall driving performance as a function of system design and subsystem performance. (Sub)system requirements are derived from behavior specification (rules), optimize performance, and prioritize resources.

FIG. 15 illustrates frequencies of violations of a stored behavioral model of operation of the AV 100, in accordance with one or more embodiments. The AV 100 is illustrated and described in more detail with reference to FIG. 1. An example stored behavioral model of operation is illustrated and described in more detail with reference to FIG. 14. In an embodiment, the one or more processors 146 determine the second risk level based on the trajectory 198 and a stored distribution of events of the operation of the AV 100 with respect to the one or more objects 416. The one or more processors 146 and the trajectory 198 are illustrated and described in more detail with reference to FIG. 1. The one or more objects 416 are illustrated and described in more detail with reference to FIG. 4.

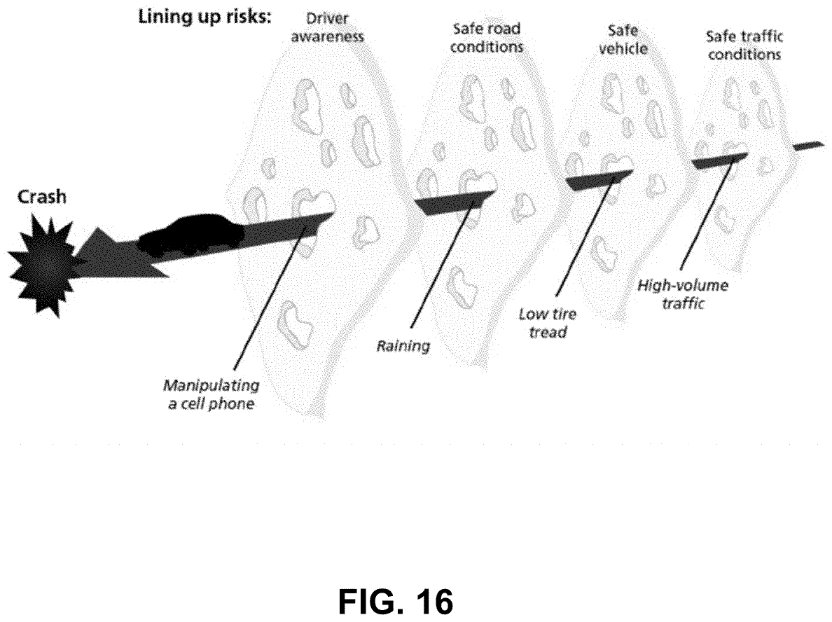

The frequencies of violations of the stored behavioral model of operation illustrated in FIG. 15 model a manner in which the AV 100 should behave on public roads. When laws are frequently underspecified and it is difficult to enumerate proper behavior for all scenarios even given perfect information, complex scenarios require tradeoffs between different behaviors. The stored behavioral model of operation illustrated in FIG. 14 is used to measure AV system level performance relative to a human driver with respect to collisions and safety envelope violations. For example, an inverse relationship exists between the frequency and severity of incidents. Verifiable quantitative relationships exist relating incidents of different severity. Incidents result from a single generative process that gives rise to a characterizable distribution illustrated and described in more detail with reference to FIG. 16.

The embodiments disclosed herein enable analyzing the severity distribution using few continuous measurements of collision severity. While there are detailed statistics about the relative prevalence of collisions resulting in fatalities, injuries, and property damage only, the discrete nature of these categories and the lack of a quantitative scale limit analysis of collision severity distributions. The embodiments disclosed thus consider continuous collision severity distributions. Four datasets using various proxies for severity are used to test whether the severity distribution of safety-critical road incidents is consistent with the models in FIGS. 13 and 15.

A first example dataset used is the National Automotive Sampling System's Crashworthiness Data System (“NASS CDS”). This is an ongoing data collection effort that investigates, reconstructs, and catalogues a random sample of all reported collisions in the United States that are severe enough to require a tow. One of the reported collision characteristics is the Delta-V, defined as “the change in velocity between pre-collision and post-collision trajectories of a vehicle” and is a canonical measure of accident severity, widely considered the best predictor of injury and fatality in a vehicle collision. Unlike collision severity levels, Delta-V can take on a continuum of values. For example, a dataset of 6,286 collisions between 2000 and 2011 was analyzed that had records from event data recorders of the involved vehicles. Delta-V was determined by taking the Euclidean norm of the reported maximum Delta-V during the collision event in the lateral and longitudinal direction. Many events in this dataset report a Delta-V of 0 miles per hour, which appears artificial since a collision implies some speed differential. In part to eliminate this potential data artifact, incidents with a Delta-V below 5 miles per hour were discarded, which are unlikely to have resulted in a tow away collision and represent well under 10% of dataset values. Other example datasets analyzed include insurance claims datasets.

FIG. 16 illustrates a stored behavioral model of operation of the AV 100, in accordance with one or more embodiments. The AV 100 is illustrated and described in more detail with reference to FIG. 1. In an embodiment, the stored behavioral model of the operation of the AV 100 includes multiple layers. Each layer has a respective position corresponding to a specific violation of the one or more violations. FIG. 16 illustrated a framework for relating safety incidents of different severity based on observations of nearly fixed ratios of high-severity accidents to lower-severity ones. The implication is that a focus on reducing minor accidents, near-misses, and hazardous conditions causes a proportional decrease in major accidents.

In an embodiment, a collision of the AV 100 with the one or more objects 416 occurs when the respective position of each layer of the multiple layers aligns. For example, the stored behavioral model of FIG. 16 views safety of complex systems as consisting of multiple layers, albeit with some holes in each layer that represent failures. The model of FIG. 16 suggests that an accident occurs only when the holes of each safety layer align. This implies the need for multiple safety layers with few holes in each (i.e., low failure probabilities) to design a safe system.

In an embodiment, a motion planning process of the AV 100 is designed, such that a probability of the respective position of each layer of the plurality of layers aligning is less than a threshold probability. For example, surrogate safety metrics measure potential driving conflicts or behaviors that do not result in a collision, but signify some degree of danger. While a broad range of techniques exists, surrogate safety metrics are specific to narrowly defined circumstances (e.g., assessing the safety of a subset of un-signalized intersections). Telematic services represent a commercial demonstration of the practical value of surrogate safety metrics, tracking cohorts of drivers who frequently brake or accelerate harshly and assigning them a higher degree of collision risk.

In an embodiment, the stored behavioral model of the operation of the AV 100 includes multiple rules of operation. Each rule of operation has a priority with respect to each other rule of operation. The priority represents a risk level of the one or more violations of the stored behavioral model. For example, surrogate safety metrics are used to assess AV safety. Thus, surrogate safety metrics are used to more rapidly evaluate road safety and integrate the concept into a holistic theoretical framework. In an embodiment, a violation of the one or more violations of the stored behavioral model of the operation of the AV 100 includes a lateral distance between the AV 100 and the one or more objects 416 falling below a threshold lateral distance. For example, the stored behavioral model of FIG. 16 is formalized into a framework for accidents (a distribution of accident severities), which, if validated, implies that the safety of complex systems can be inferred by observing surrogate safety metrics. In an embodiment, the priority of the rule of operation is adjusted based on a frequency of the violation. For example, empirical evidence from human driver data is used in support of the application of the stored behavioral model of FIG. 16 to road safety.

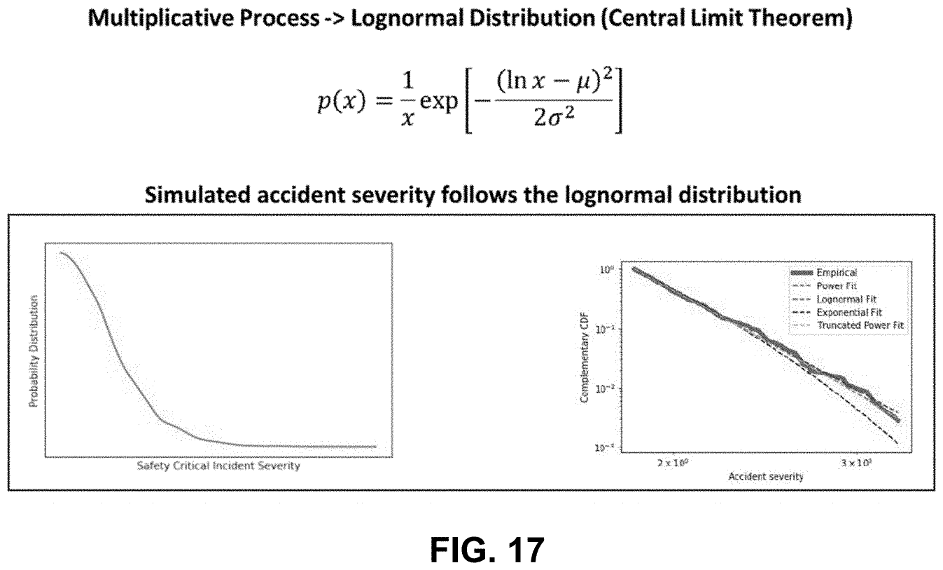

FIG. 17 illustrates a stored distribution of events of operation of the AV 100 with respect to the one or more objects 416, in accordance with one or more embodiments. The AV 100 and objects 416 are illustrated and described in more detail with reference to FIGS. 1 and 4. In an embodiment, the stored distribution of events includes a log-normal probability distribution of independent random variables. Each random variable represents a risk level of a hazard of the operation of the AV 100. For example, the stored distribution of events of FIG. 17 implies that collision events follow a log-normal distribution. Hence, observations of low-severity events, including behavioral metrics, reveal the frequency of high-severity ones. The stored distribution of events illustrated in FIG. 17 thus enables AV design using redundant systems and resistance to single point failures. For example, the stored distribution of events can be used to formalize a predictable relationship between the frequency and severity of safety-critical driving incidents based on existing theoretical frameworks for accidents.

In an embodiment, mathematical analysis is used to determine that the stored behavioral model (see FIG. 16) for accident causation and accident severity imply a specific distributional form of incident severity. The stored behavioral model of FIG. 16 is formalized as a mathematical expression in FIG. 17 for the severity of a safety-critical driving incident resulting from a hazard. Safety-critical driving incidents (events) are modeled as incidents that contain an element of increased risk but that may or may not result in a collision. The Central Limit Theorem is used in FIG. 17 to show that this mathematical expression implies a log-normal distribution of the severity of safety-critical events.

In an embodiment, a distributional form of four of diverse datasets that approximate motor vehicle incident severity can further be analyzed. The mathematical analysis (see FIG. 17) suggests that the stored behavioral model are consistent with a log-normal distribution of accident severity. The empirical analysis shown in FIG. 17 confirms that all five datasets closely fit a log-normal distribution. A sixth example dataset suggests a significant increasing relationship between near-collisions and collisions. The experiments illustrated in FIG. 17 support the use of high-frequency low-severity events to more rapidly assess the safety of motor vehicles or individual drivers. Moreover, complex systems designed for robustness to single-point failures, including autonomous vehicles, are consistent with the same theoretical frameworks, allowing more rapid deployment of safer technologies using the embodiments disclosed herein.

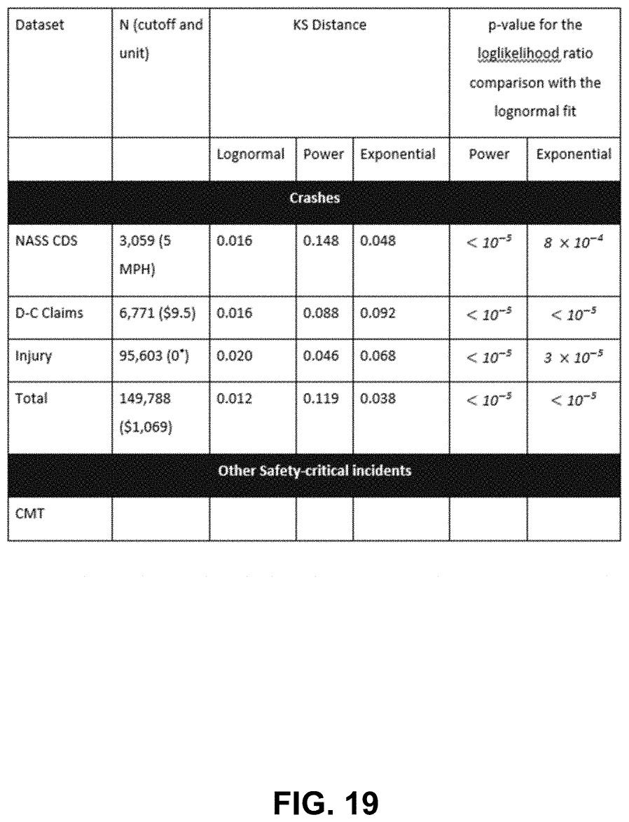

In an embodiment, several common “heavy-tailed” candidate distributions (power law, exponential, log-normal) are used to model the severity of collisions. The power law and exponential distribution have monotonically decreasing density functions (i.e., they have no left tail). Hence, they are fit only to the right tail of the data. To ensure a fair comparison between the three candidate distributions, the left tail of each dataset is discarded relative to its peak, which is obtained by dividing the dataset into 100 percentiles and taking the low end of the percentile containing the peak number of samples (illustrated in FIG. 19). Since the log-normal distribution has a left tail, this procedure favors the other two candidate distributions. Disregarding the left tail effectively ignores collisions with very low severity (i.e., low claim amounts or Delta-V), which suffer most from underreporting.

In an embodiment, it is assessed whether an empirical dataset follows a log-normal distribution, a different candidate distribution, or no candidate distribution. In an experiment, the Python powerlaw package was used, which uses maximum likelihood estimation to obtain a best fit for each candidate distribution. For each dataset and candidate distribution, the Kolmogorov-Smirnov (KS) distance was determined, defined as the maximum difference between the cumulative empirical distribution function and the candidate fitted cumulative distribution function. The KS distance provides a measure of how well each individual candidate distribution fits the data. To determine more directly whether the log-normal distribution provides a better fit than the two other candidate distributions, the p-value is considered for the significance of the log likelihood ratio that the data came from the log-normal distribution compared to each other candidate distribution. A small p-value provides evidence in favor of the log-normal distribution.

In an experiment, a record of trips with the safety-critical incident dataset was combined to determine the total number of near-collisions each driver had over the course of the study and divided drivers into cohorts based on how many near-collisions they experienced during the study. For larger numbers of near-collisions, the dataset contains few drivers. These drivers were combined into the same cohort until the number of miles driven in the cohort exceeded one million miles and these cohorts were assigned the average number of near-collisions for all drivers added to the cohort. Spearman's rank correlation was determined, which measures the strength of monotonic (not necessarily linear) relationship, and its significance to investigate whether driver cohorts with higher rates of near-collisions tend to experience higher rates of collisions and severe collisions as well.

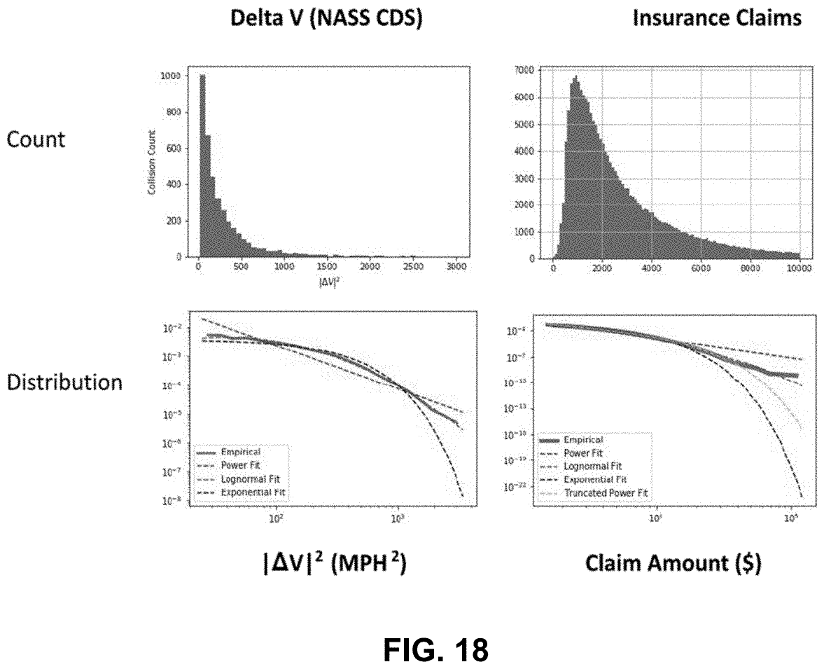

FIG. 18 illustrates a stored distribution of events of operation of the AV 100 with respect to the one or more objects 416, in accordance with one or more embodiments. The AV 100 and objects 416 are illustrated and described in more detail with reference to FIGS. 1 and 4. In an embodiment, a violation of the one or more violations represents a deceleration of the AV 100 exceeding a threshold deceleration. For example, a risk level is assessed from non-collision outcomes such as the frequency of near-collisions and encountering hazardous driving situations. To assess whether a single framework can unite pre-collision and collision behaviors, two example datasets were analyzed.

A first example dataset represents readings from a mobile device installed in consumer vehicles used to analyze driver safety. The first dataset is a randomly selected sample of hard braking events above a threshold deceleration. Hard braking is an evasive maneuver that correlates with elevated collision risk. To assess whether hard braking events place on the same continuum of outcomes as collisions, it was evaluated for log-normal fit using the same methods used for collision data.

In an embodiment, a violation of the one or more violations represents a lateral distance from the AV 100 to the one or more objects 416 falling below a threshold lateral distance (near miss). For example, a second dataset derives from the second Strategic Highway Research Program (SHRP-2) naturalistic driving study, the largest study of real-world driving behavior to date. Two extracted datasets were used—the first had trip records for drivers participating in the study (3,546 drivers, 5.4 million captured trips, and 32 million fully documented miles travelled) and the second had a record of safety-critical events (8,717 collisions and near-collisions). The SHRP-2 study divided safety critical events into one of five categories, with collision severities of 1-4 and near-collisions. For the purposes of analysis, collisions with property damage, injuries, or fatalities are classified as “severe” (286 events). Any other contact event except for those classified as level 4 (i.e., tire departures from the roadway or curb strikes that involve no element of risk) are classified as “mild” (775 events). Level 4 collisions and non-collision incidents requiring evasive action are classified as “near-collisions” (7,656 events).

FIG. 19 illustrates an example stored distribution of events of operation of the AV 100 with respect to the one or more objects 416, in accordance with one or more embodiments. The AV 100 and objects 416 are illustrated and described in more detail with reference to FIGS. 1 and 4. The stored behavioral model of FIG. 16 is conceptualized as a series of independent factors that interact with a hazardous driving situation to either magnify or mitigate the hazard. For example, a hazard can develop due to the actions of another vehicle on the road. Whether a collision occurs depends on a number of other factors, e.g., the reaction time of the driver, road geometry, weather, speed, vehicle capabilities and maintenance state. If one or more factors are highly favorable, the hazard is extinguished and no safety-critical incident occurs. In reality, factors are less than fully dispositive and cannot fully extinguish a hazard; they may even exacerbate them and thus become additive (e.g., poor weather), so a factor can also serve as a hazard (e.g., a poorly maintained car can either be a hazard, or a factor that exacerbates another hazard). If the other factors are only marginally effective at mitigating a hazard, a near-collision or mild collision will occur, and if the other factors are largely ineffective at mitigating a hazard, a severe collision may occur.

In an embodiment, the stored distribution of events of FIG. 19 includes a log-normal probability distribution of independent random variables. Each random variable represents a risk level of a hazard of the operation of the vehicle. For example, each collision has at its primary root cause a hazard. The distribution of collision severities is determined as in equation (1).

S=ΣᵢwᵢSᵢ (1)

Here, Sᵢ is a random variable representing the severity of safety-critical incidents associated with the occurrence of hazard i and wᵢ is the proportion of safety-critical incidents that are due to hazard i. For a single type of hazard, the distribution of outcomes is determined as in equation (2).

Sᵢ= [symbol] Hᵢ×X [symbol] ₁ᵢ×X₂ᵢ×X₃ᵢ . . . X_{Ni} (2)

Here, Hᵢ is a random variable representing the severity of hazard i and each Xⱼᵢ is a random variable representing the impact of factor j on mitigating (or exacerbating) specific hazard i. Taking the logarithm of both sides results in equation (3).

log Sᵢ=log [symbol] Hᵢ+log+log X [symbol] ₁ᵢ+log X₂ᵢ+log X₃ᵢ . . . +log X_{Ni} (3)

Since the right side in equation (3) is a sum of a series of independent random variables, they will converge to a normal distribution if either (1) all Hᵢ and Xⱼᵢ are identically distributed or (2) Hᵢ and Xⱼᵢ meet the Lyapunov or Lindeberg Central Limit Theorem conditions. If so, then Sᵢ is well-approximated by the log-normal probability distribution as in equation (4).

p(x)=1/x exp[−((ln x−μ²)/(2σ²)] (4)

Where μ and σ are the mean and standard deviation, respectively, of the normally distributed quantity log Sᵢ. While disparate hazards and factors are harder to model by anything close to identically distributed random variables, so long as no small subset dominates the random variables, the random variables are mostly independent, and there is a sufficiently large number of them, then Sᵢ will converge to a lognormal distribution. Thus, if numerous mostly uncorrelated factors impact the severity of collisions, as the model illustrated in FIG. 16 posits, then the severity distribution will tend towards a log-normal distribution.

Equation (2) enables the severity of all collisions to be captured by summing over a weighted likelihood of encountering hazard i. The sum of multiple log-normal distributions persists as a log-normal distribution and converges only very slowly to a normal distribution. Thus, the severity outcome of car collisions (or any process that follows the model illustrated in FIG. 16) will be log-normal. There will be exceptional hazards that represent single modes of failure (e.g., a driver falling asleep, the consequences of which skew towards severe outcomes) and that will not follow a log-normal distribution, but so long as a system is resilient to single-point failures, the distribution of severity will be log-normal.

As discussed earlier, the model of FIG. 16 represents a qualitative distributional form for certain classes of safety-critical incidents characterized by a long right tail. The analysis above suggests that a distribution naturally emerges for AV systems in which most incidents trace to a combination of factors and suggests that the true distribution form of events is a log-normal distribution. The upper section of FIG. 19 summarizes the results of the analysis of the distribution of collision severities, confirming for all datasets that (i) the log-normal fit results in by far the smallest KS distance to the data among the candidate distributions, and (ii) the log-normal fit is highly significantly better than the fits to the other candidate distributions.

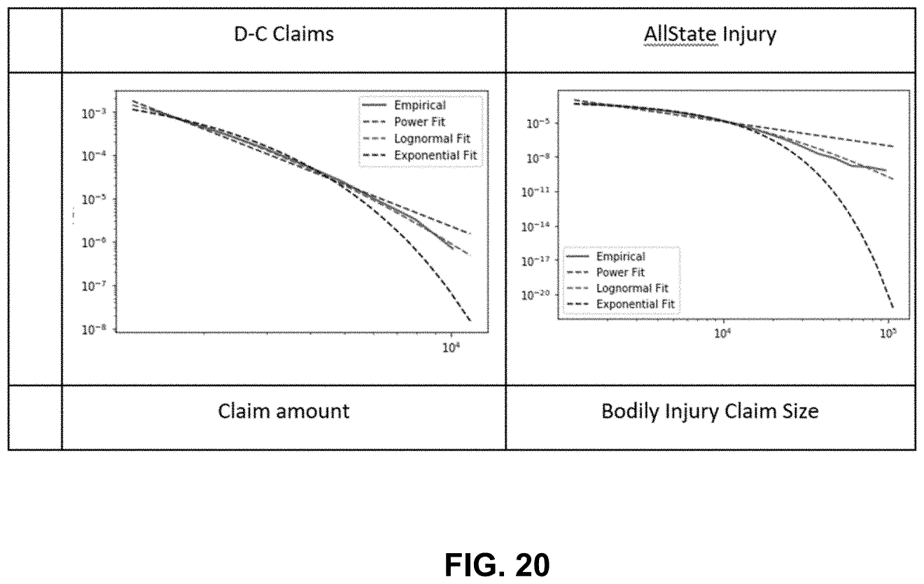

FIG. 20 illustrates an example stored distribution of events of operation of the AV 100 with respect to the one or more objects 416, in accordance with one or more embodiments. The AV 100 and objects 416 are illustrated and described in more detail with reference to FIGS. 1 and 4. FIG. 20 visually represents the fits for two of the claims datasets. Each plot shows, on a log scale, the fitted probability distribution function of each candidate distribution against the empirical probability mass function. In both, visual inspection shows that the log-normal distribution is likely the best fit, complementing the numerical results from FIG. 19.

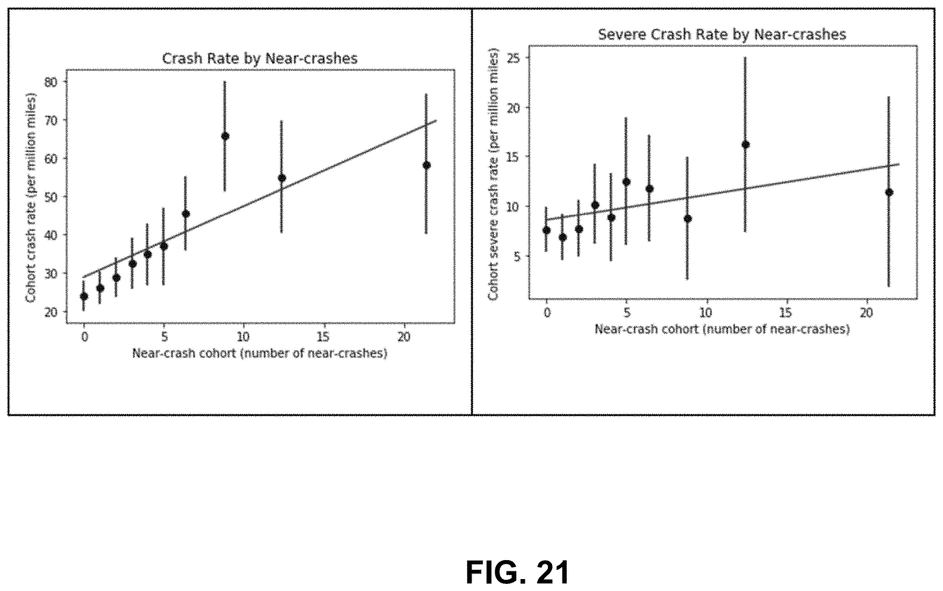

FIG. 21 illustrates an example stored distribution of events of operation of the AV 100 with respect to the one or more objects 416, in accordance with one or more embodiments. The AV 100 and objects 416 are illustrated and described in more detail with reference to FIGS. 1 and 4. The analysis of the SHRP-2 naturalistic driving data shows a strong increasing relationship between a cohort's near-collision rate and its collision rate (Spearman R=0.95, p<0.001). The increasing relationship was somewhat weaker but still strong and significant when only considering the relationship between cohort near-collision rate and severe collision rate (Spearman R=0.75, p=0.01). These findings support the notion that the frequency of driver involvement in near-collisions is a strong signal of driver capability and overall collision rate. FIG. 21 visualizes this relationship, displaying driver cohort near-collisions against cohort collision and severe collision rates, with a best fit line and the 95% confidence intervals. Due to individual variation and outliers, there is only a weak correlation between near-collision rates and collision rates at the individual driver level (rather than the cohort level reported above), but it is highly significant for both collisions (Spearman R=0.19, p<0.001) and severe collisions (Spearman R=0.12, p<0.001). Since SHRP-2 has a discrete outcome of “near-collision,” it is more difficult to evaluate the relative severity of different near-collisions and whether they follow a log-normal distribution. However, the evasive braking maneuver dataset from CMT provides a measure of severity of both collisions and safety-critical incidents in Delta-V. The bottom section of FIG. 19 shows that, like collision events, hard braking events also follow a log-normal distribution.

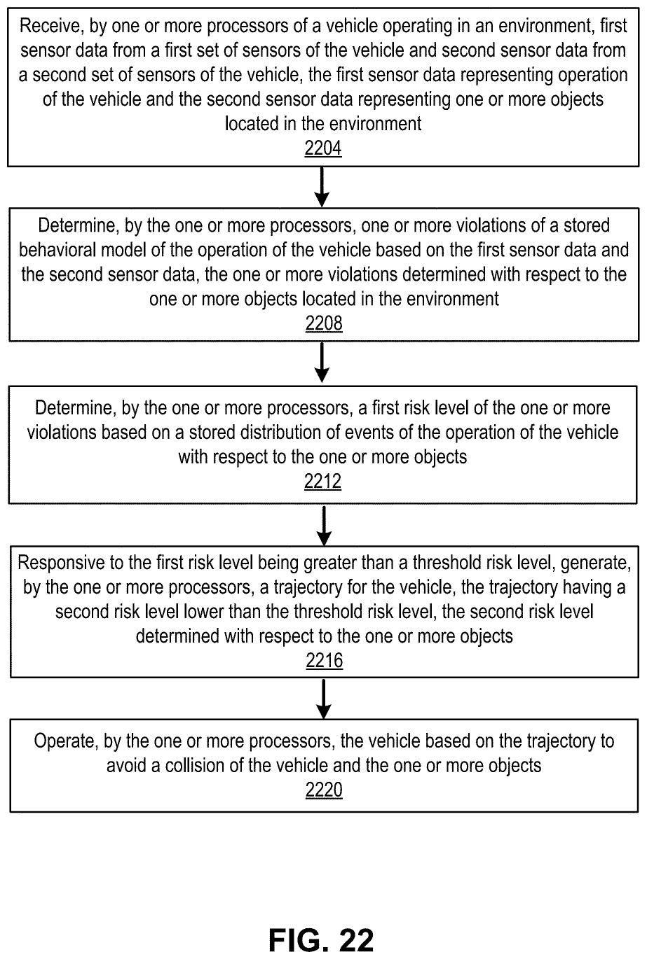

FIG. 22 is a flow diagram illustrating an example process for AV operation using a behavioral rule model, in accordance with one or more embodiments. In an embodiment, the process of FIG. 22 is performed by the AV 100, described in more detail with reference to FIG. 1. A specific entity, for example, the perception module 402 or the planning module 404 performs some or all of the steps of the process in other embodiments. Likewise, embodiments may include different and/or additional steps, or perform the steps in different orders. The perception module 402 and the planning module 404 are illustrated and described in more detail with reference to FIG. 4.

The AV 100 receives 2204 first sensor data from a first set of sensors 121 of the AV 100 and second sensor data from a second set of sensors 122 of the AV 100. The first set of sensors 121 and second set of sensors 122 are described in more detail with reference to FIG. 1. The first sensor data represents operation of the AV 100 and the second sensor data represents one or more objects 416 located in an environment 190. The one or more objects 416 are described in more detail with reference to FIG. 4. The environment 190 is described in more detail with reference to FIG. 1.

The AV 100 determines 2208 one or more violations of a stored behavioral model of the operation of the AV 100 based on the first sensor data and the second sensor data. An example stored behavioral model is described in more detail with reference to FIG. 14. The one or more violations are determined with respect to the one or more objects 416 located in the environment 190.

The AV 100 determines 2212 a first risk level of the one or more violations based on a stored distribution of events of the operation of the AV 100 with respect to the one or more objects 416. An example stored distribution of events is described in more detail with reference to FIG. 17.

Responsive to the first risk level being greater than a threshold risk level, the AV 100 generates 2216 a trajectory 198 for the AV 100. The trajectory 198 is described in more detail with reference to FIG. 1. The trajectory 198 has a second risk level lower than the threshold risk level. The second risk level is determined with respect to the one or more objects 416.

The AV 100 is operated 2220 based on the trajectory 198 to avoid a collision of the AV 100 and the one or more objects 416. For example, a control module 406 of the AV 100 is used to operate the AV 100. The control module 406 is described in more detail with reference to FIG. 4.

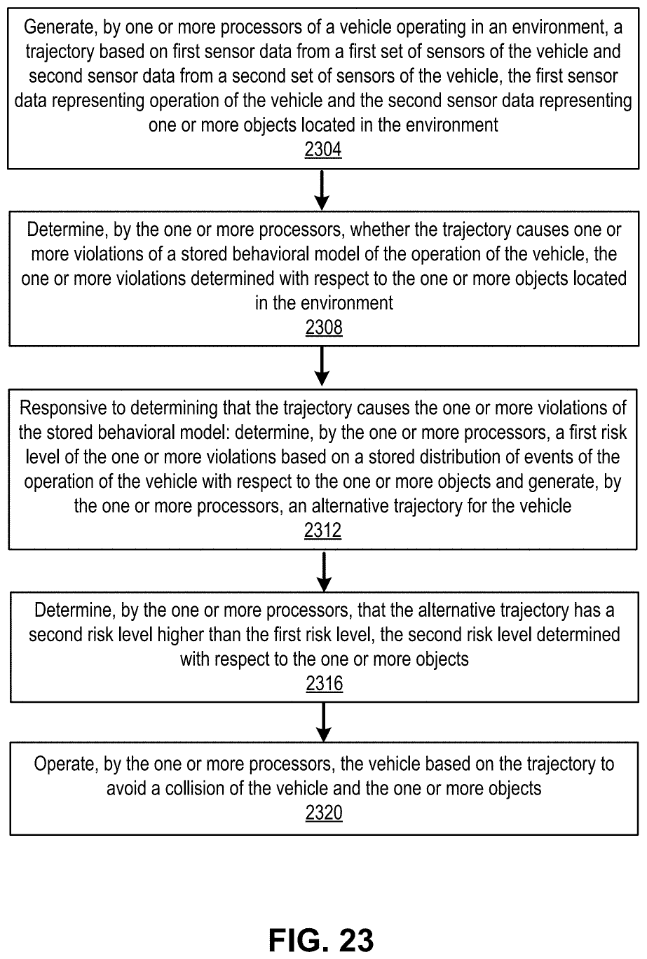

FIG. 23 is a flow diagram illustrating an example process for operation of the AV 100 using a behavioral rule model, in accordance with one or more embodiments. The AV 100 is illustrated and described in more detail with reference to FIG. 1. In an embodiment, the process of FIG. 23 is performed by the planning circuit 404, described in more detail with reference to FIG. 4. Other entities, for example, the perception module 402 or the control module 406 perform some or all of the steps of the process in other embodiments. Likewise, embodiments may include different and/or additional steps, or perform the steps in different orders. The perception module 402 and the control module 406 are illustrated and described in more detail with reference to FIG. 4.

The AV 100 generates 2304 a trajectory 198 based on first sensor data from a first set of sensors 121 of the AV 100 and second sensor data from a second set of sensors 122 of the AV 100. The first set of sensors 121 and second set of sensors 122 are described in more detail with reference to FIG. 1. The first sensor data represents operation of the AV 100 and the second sensor data represents one or more objects 416 located in an environment 190. The one or more objects 416 are described in more detail with reference to FIG. 4. The environment 190 is described in more detail with reference to FIG. 1.

The AV 100 determines 2308 whether the trajectory 198 causes one or more violations of a stored behavioral model of the operation of the AV 100. An example stored behavioral model is described in more detail with reference to FIG. 14. The one or more violations are determined with respect to the one or more objects 416 located in the environment 190.

Responsive to determining that the trajectory 190 causes the one or more violations of the stored behavioral model, the AV 100 determines 2312 a first risk level of the one or more violations based on a stored distribution of events of the operation of the AV 100 with respect to the one or more objects 416. An example stored distribution of events is described in more detail with reference to FIG. 17. The AV 100 generates an alternative trajectory for the AV 100.

The AV 100 determines 2316 that the alternative trajectory has a second risk level higher than the first risk level. The second risk level is determined with respect to the one or more objects 416.

The AV 100 is operated 2320 based on the trajectory 198 to avoid a collision of the AV 100 and the one or more objects 416. For example, a control module 406 of the AV 100 is used to operate the AV 100. The control module 406 is described in more detail with reference to FIG. 4.

Using the embodiments disclosed herein, safety-critical incidents are shown to result from the same causal mechanisms regardless of whether they lead to a loss (i.e., a collision in the case of motor vehicle incidents), and (ii) consistent with the model illustrated and described in more detail with reference to FIG. 16, the severity of the loss is multiplicative in nature, leading to a log-normal severity distribution. In experiments, near-crashes correlate strongly with crashes (see FIG. 21). At an aggregate level, experiments performed using the disclosed embodiments show that the frequency of hard-braking events in a cohort also correlates with the collision rate in that cohort, as hard-braking events often result from a traffic conflict that resolves without a collision. Thus, aggressive braking is an indicator of more severe conflicts and a higher collision frequency. Hard braking incidents follow the same distributional form as collision incidents using the same variable (Delta-V), which is indicative of a common causative mechanism. The embodiments disclosed herein can be used to determine that evasive braking actions follow the same form of frequency-severity distribution as crashes themselves.

The embodiments disclosed herein can also be used to determine that five diverse datasets of crash and safety-critical incidents all closely follow a log-normal distribution. Hence, an implementation for evaluating crash risk based on how often a driver encounters a hazardous situation is disclosed. While the embodiments can accelerate assessing any road safety intervention, they are especially useful in the case of AVs. Safety standards for AVs and other complex systems recommend redundant subsystems with multiple safety measures to minimize single points of failure. These recommendations are consistent with the model of FIG. 16 and the corresponding analysis in FIG. 17 suggests that they result in a predictable relationship between less severe and more severe events, with more severe events occurring at increasingly low frequencies.

The AV community is taking steps towards the definition of good behaviors for AVs that measure behavioral competencies beyond avoiding collisions. The embodiments disclosed herein can be used to evaluate, either in simulation or by aggregation of real-world data, how well leading (e.g., pre-crash) metrics for AVs predict risk. Leading metrics can include hard braking, close following (low time to collision), or others. Unlike system-specific software or other metrics, metrics which evaluate safe road performance have the advantage of being technology-neutral (i.e., they can assess safety independent of specific technological implementation). The analysis described herein shows that the product of random variables will converge to a log-normal distribution even with some dependence between random variables. Further, formally modeling accidents using the form of equation (3) contributes to an understanding of exactly how different factors combine to affect incident severity. Furthermore, consideration of other events than near-crashes in naturalistic driving studies can eliminate some of the statistical fluctuations that limit analysis of the SHRP-2 data. Finally, a comprehensive analysis of safety-critical events involving AVs can be implemented.

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further including,” in the foregoing description or following claims, what follows this phrase can be an additional step or entity, or a sub-step/sub-entity of a previously-recited step or entity.

What is claimed is:

1. A method comprising:
receiving, by one or more processors of a vehicle operating in an environment, first sensor data from a first set of sensors of the vehicle and second sensor data from a second set of sensors of the vehicle, the first sensor data representing operation of the vehicle and the second sensor data representing one or more objects located in the environment;
determining, by the one or more processors, one or more violations of a stored behavioral model of the operation of the vehicle based on the first sensor data and the second sensor data, the one or more violations determined with respect to the one or more objects located in the environment;
determining, by the one or more processors, a first risk level of the one or more violations based on a stored distribution of events of the operation of the vehicle with respect to the one or more objects;
responsive to the first risk level being greater than a threshold risk level, generating, by the one or more processors, a trajectory for the vehicle, the trajectory having a second risk level lower than the threshold risk level, the second risk level determined with respect to the one or more objects; and
operating, by the one or more processors, the vehicle based on the trajectory to avoid a collision of the vehicle and the one or more objects.

2. The method of claim 1, wherein the first set of sensors comprise at least one of an accelerometer, a steering wheel angle sensor, a wheel sensor, or a brake sensor.

3. The method of claim 1, wherein the first sensor data comprises at least one of a speed of the vehicle, an acceleration of the vehicle, a heading of the vehicle, an angular velocity of the vehicle, or a torque of the vehicle.

4. The method of claim 1, wherein the second set of sensors comprise at least one of a LiDAR, a RADAR, a camera, and a microphone.

5. The method of claim 1, wherein the second sensor data comprises at least one of an image of the one or more objects, a speed of the one or more objects, an acceleration of the one or more objects, or a lateral distance between the one or more objects and the vehicle.

6. The method of claim 1, further comprising determining, by the one or more processors, the second risk level based on the trajectory and the stored distribution of events of the operation of the vehicle with respect to the one or more objects.

7. The method of claim 1, wherein the stored distribution of events comprises a log-normal probability distribution of independent random variables, each random variable representing a risk level of a hazard of the operation of the vehicle.

8. The method of claim 1, wherein the stored behavioral model of the operation of the vehicle comprises a plurality of rules of operation, each rule of operation of the plurality of rules of operation having a priority with respect to each other rule of operation of the plurality of rules of operation, the priority representing a risk level of the one or more violations of the stored behavioral model.

9. The method of claim 8, wherein a violation of the one or more violations of the stored behavioral model of the operation of the vehicle comprises a lateral distance between the vehicle and the one or more objects falling below a threshold lateral distance.

10. The method of claim 9, further comprising adjusting the priority of the rule of operation based on a frequency of the violation.

11. The method of claim 1, further comprising adjusting a motion planning process of the vehicle based on a frequency of the one or more violations of the stored behavioral model to decrease the second risk level.

12. The method of claim 11, further comprising determining a risk level of the motion planning process of the vehicle based on the frequency of the one or more violations of the stored behavioral model.

13. An autonomous vehicle comprising:
one or more computer processors; and
one or more non-transitory storage media storing instructions which, when executed by the one or more computer processors, cause performance of operations comprising:
receiving, by the one or more computer processors of the autonomous vehicle operating in an environment, first sensor data from a first set of sensors of the vehicle and second sensor data from a second set of sensors of the vehicle, the first sensor data representing operation of the vehicle and the second sensor data representing one or more objects located in the environment;
determining, by the one or more computer processors of the autonomous vehicle, one or more violations of a stored behavioral model of the operation of the vehicle based on the first sensor data and the second sensor data, the one or more violations determined with respect to the one or more objects located in the environment;
determining, by the one or more computer processors of the autonomous vehicle, a first risk level of the one or more violations based on a stored distribution of events of the operation of the vehicle with respect to the one or more objects;
responsive to the first risk level being greater than a threshold risk level, generating, by the one or more computer processors of the autonomous vehicle, a trajectory for the vehicle, the trajectory having a second risk level lower than the threshold risk level, the second risk level determined with respect to the one or more objects; and
operating, by the one or more computer processors of the autonomous vehicle, the vehicle based on the trajectory to avoid a collision of the vehicle and the one or more objects.

14. The autonomous vehicle of claim 13, wherein the first set of sensors comprise at least one of an accelerometer, a steering wheel angle sensor, a wheel sensor, or a brake sensor.

15. The autonomous vehicle of claim 13, wherein the first sensor data comprises at least one of a speed of the vehicle, an acceleration of the vehicle, a heading of the vehicle, an angular velocity of the vehicle, or a torque of the vehicle.

16. The autonomous vehicle of claim 13, wherein the second set of sensors comprise at least one of a LiDAR, a RADAR, a camera, and a microphone

17. One or more non-transitory storage media storing instructions which, when executed by one or more computing devices, cause performance of operations comprising:
receiving, by one or more processors of a vehicle operating in an environment, first sensor data from a first set of sensors of the vehicle and second sensor data from a second set of sensors of the vehicle, the first sensor data representing operation of the vehicle and the second sensor data representing one or more objects located in the environment;
determining, by the one or more processors, one or more violations of a stored behavioral model of the operation of the vehicle based on the first sensor data and the second sensor data, the one or more violations determined with respect to the one or more objects located in the environment;
determining, by the one or more processors, a first risk level of the one or more violations based on a stored distribution of events of the operation of the vehicle with respect to the one or more objects;
responsive to the first risk level being greater than a threshold risk level, generating, by the one or more processors, a trajectory for the vehicle, the trajectory having a second risk level lower than the threshold risk level, the second risk level determined with respect to the one or more objects; and
operating, by the one or more processors, the vehicle based on the trajectory to avoid a collision of the vehicle and the one or more objects.

18. The one or more non-transitory storage media of claim 17, wherein the first set of sensors comprise at least one of an accelerometer, a steering wheel angle sensor, a wheel sensor, or a brake sensor.

19. The one or more non-transitory storage media of claim 17, wherein the first sensor data comprises at least one of a speed of the vehicle, an acceleration of the vehicle, a heading of the vehicle, an angular velocity of the vehicle, or a torque of the vehicle.

20. The one or more non-transitory storage media of claim 17, wherein the second set of sensors comprise at least one of a LiDAR, a RADAR, a camera, and a microphone.
